(19) United States
(12) Patent Application Publication
(10) Pub. No.: US 2023/0111758 A1
(43) Pub. Date: Apr. 13, 2023

(54) BUSH-TYPE MOUNT FOR VEHICLE

(71) Applicants: Hyundai Motor Company, Seoul (KR); Kia Corporation, Seoul (KR)

(72) Inventors: Jang Ho KIM, Yongin-Si (KR); Won Goo LEE, Hwaseong-Si (KR)

(73) Assignees: Hyundai Motor Company, Seoul (KR); Kia Corporation, Seoul (KR)

(21) Appl. No.: 17/952,924

(22) Filed: Sep. 26, 2022

(30) Foreign Application Priority Data
Oct. 12, 2021 (KR) 10-2021-0134641

(51) Int. Cl. F16C 35/02; F16C 17/02

(52) U.S. Cl. CPC F16C 35/02; F16C 17/02

(57) ABSTRACT

The present disclosure provides a bush-type mount for a vehicle that has a high degree of freedom of setting of the properties thereof along three axes so as to increase the property thereof in the axial direction (the longitudinal direction of the vehicle) to the level of the property thereof in the radial direction (the vertical direction and the lateral direction of the vehicle) or to increase both the property thereof in the axial direction and the property thereof in the radial direction, thereby sufficiently securing the properties of an entire mount system in all directions irrespective of the direction in which the bush-type mount is disposed.

### CROSS-REFERENCE TO RELATED APPLICATION

This application claims under 35 U.S.C. §119(a) the benefit of priority from Korean Patent Application No. 10-2021-0134641 filed on Oct. 12, 2021, the entire contents of which are incorporated herein by reference.

### BACKGROUND

### (a) Technical Field

The present disclosure relates to a bush-type mount for a vehicle. More particularly, it relates to a bush-type mount for a vehicle that has an improved structure enabling adjustment of the properties thereof along three axes with a high degree of adjustment freedom so as to, for example, increase the axial property thereof to the level of the radial property thereof.

### (b) Background Art

In general, a powertrain of a vehicle, which includes an engine and a transmission, is supported by a plurality of mounts so as to be mounted to the vehicle body. Also, a motor for driving an electric vehicle is supported by a plurality of mounts, which function to distribute a load and to control the behavior of the vehicle, so as to be mounted to the vehicle body.

Various types of mounts designed to improve the noise, vibration and harshness (NVH) performance of a vehicle may be used. A bush-type mount is used as one example of such a mount.

Referring to FIGS. 1 and 2, a conventional bush-type mount 10 may include an outer pipe 12, an inner pipe 16, and a rubber part 14 interconnecting the outer pipe 12 and the inner pipe 16. A structure for adjusting the characteristics and displacement of the bush-type mount may be additionally formed at the inner pipe.

The outer pipe 12 is press-fitted into a separate bracket formed in a vehicle body, such as a sub-frame, and the inner pipe 16 is bolted to bosses formed in parts such as an engine and a transmission or parts such as a motor and a speed reducer. Alternatively, the outer pipe is press-fitted into a housing of the motor or the speed reducer, and the inner pipe is bolted to a bracket or a boss formed in the vehicle body. Thereby, the bush-type mount 10 functions to isolate and dampen vibrations.

In this case, the radial property (e.g. stiffness) of the bush-type mount 10 may be determined based on the extent to which the rubber part 14 is expanded or compressed when the distance between the outer pipe 12 and the inner pipe 16 increases or decreases due to vibrations.

Accordingly, the radial property (e.g. stiffness) of the bush-type mount 10 may be determined based on the hardness of the rubber part 14, which refers to the amount of external force that the rubber material constituting the rubber part 14 is capable of withstanding, and the amount and shape of the rubber constituting the rubber part 14. Also, the radial property (e.g. stiffness) of the bush-type mount 10 may be adjusted by varying the hardness, thickness, and shape of the rubber part 14, which are influenced by the inner diameter of the outer pipe 12 and the outer diameter of the inner pipe 16.

Since the rubber part 14 is disposed between the outer pipe 12 and the inner pipe 16 to interconnect the same, the axial property of the bush-type mount 10 may be determined based on the amount of shear deformation of the rubber part 14 caused by a load in the axial direction. Because the resistance to shear deformation of the rubber part 14 caused by a load in the axial direction is not greater than the resistance to compressive or tensile deformation, the axial property of the bush-type mount is set to be lower than the radial property thereof.

The above-described conventional bush-type mounts are mounted to a frame of a vehicle body and power electronic (PE) parts (e.g. a motor and a speed reducer) of an electric vehicle in a three-point support structure.

For example, as shown in FIG. 3, three bush-type mounts 10, in which the axial property is set to be lower than the radial property as described above, are respectively press-fitted into separate brackets 20, and are mounted to a vehicle body in a three-point support structure such that one bush-type mount is located at a relatively forward position and two bush-type mounts are located at two relatively rearward positions.

In this case, the outer pipes of the bush-type mounts 10 are press-fitted into the brackets 20 in the lateral direction (width direction) of the vehicle, the brackets 20 are mounted to a PE part 30, and the inner pipes of the bush-type mounts 10 are bolted to a frame 40 of the vehicle body.

Since the three bush-type mounts 10 are press-fitted into the brackets 20 in the lateral direction of the vehicle, the axial directions of the three bush-type mounts 10 are parallel to the lateral direction of the vehicle.

Alternatively, in order to improve ease of assembly and to reduce production costs and weight, as shown in FIG. 4, three bush-type mounts 10, in which the axial property is set to be lower than the radial property as described above, may be mounted such that one bush-type mount 10 is mounted at a relatively forward position without a separate bracket such that the axial direction thereof is parallel to the longitudinal direction of the vehicle and such that two bush-type mounts 10 are mounted at two relatively rearward positions such that the axial directions thereof are parallel to the lateral direction of the vehicle.

In this case, as shown in FIG. 4, the outer pipe of the bush-type mount 10 located at the relatively forward position is press-fitted into the frame 40 of the vehicle body so as to be integrated therewith, and the inner pipe of the bush-type mount 10 is bolted to the PE part 30.

However, when mounting the above-described conventional bush-type mounts to the frame of the vehicle body and the power electronic (PE) parts (e.g. the motor and the speed reducer) of the electric vehicle in a three-point support structure, it is not possible to set the properties of the entire mount system in all directions to desired levels, thus failing to appropriately respond to impacts and aftershock and accordingly deteriorating driving performance.

In other words, because there is a limitation to the extent to which the property of the conventional bush-type mount in each direction is capable of being set, if the arrangement of the conventional bush-type mounts changes for reasons of, for example, reducing production costs and weight and thus the properties of the entire mount system in all directions are not set to desired levels, it is difficult to appropriately respond to impacts and aftershock, leading to deterioration in driving performance.

For example, as described above with reference to FIG. 4, in the case in which, among the three bush-type mounts 10, one bush-type mount 10 is mounted at a relatively forward position such that the axial direction thereof is parallel to the longitudinal direction of the vehicle and two bush-type mounts 10 are mounted at two relatively rearward positions such that the axial directions thereof are parallel to the lateral direction of the vehicle, the property of the entire mount system in the longitudinal direction of the vehicle, among the properties thereof in all directions, is lowered because each of the bush-type mounts is formed such that the axial property thereof is set to be lower than the radial property thereof, thus failing to appropriately respond to impacts and aftershock and accordingly deteriorating driving performance.

The above information disclosed in this Background section is only for enhancement of understanding of the background of the invention and therefore it may contain information that does not form the related art that is already known in this country to a person of ordinary skill in the art.

### SUMMARY OF THE DISCLOSURE

The present invention has been made in an effort to solve the above-described problems associated with the related art, and it is an object of the present invention to provide a bush-type mount for a vehicle that has a high degree of freedom of setting of the properties thereof along three axes so as to increase the property thereof in the axial direction (the longitudinal direction of the vehicle) to the level of the property thereof in the radial direction (the vertical direction and the lateral direction of the vehicle) or to increase both the property thereof in the axial direction and the property thereof in the radial direction, thereby sufficiently securing the properties of an entire mount system in all directions irrespective of the direction in which the bush-type mount is disposed.

According to first to fifth embodiments of the present invention for accomplishing the above and other objects, a bush-type mount for a vehicle may include an outer pipe fitted into a press-fit hole formed in a frame of a vehicle body in the longitudinal direction of the vehicle, an inner pipe having a bolt hole formed therein so as to be mounted to a PE part, the inner pipe being disposed inside the outer pipe so as to be oriented in the longitudinal direction, a rubber part formed in a vulcanization-molding process so as to fill the space between the outer pipe and the inner pipe, at least two supports integrally formed at the front end and the rear end of the outer pipe so as to be in close contact with the front surface and the rear surface of the rubber part, and a bulge part integrally formed with the outer circumferential portion of the inner pipe to compress or expand the rubber part in the same direction as the direction of movement of the inner pipe, the inner pipe being mounted so as to move in the longitudinal direction.

According to the first embodiment of the present invention, the at least two supports may include a front-left support and a front-right support integrally formed with the front end of the outer pipe at left and right positions so as to be in close contact with the front surface of the rubber part to support the rubber part together with the bulge part so as to compress and expand the rubber part, and may further include a rear-upper support and a rear-lower support integrally formed with the rear end of the outer pipe at upper and lower positions so as to be in close contact with the rear surface of the rubber part to support the rubber part together with the bulge part so as to compress and expand the rubber part.

According to the first embodiment of the present invention, the bulge part may include a left bulge plate and a right bulge plate protruding leftwards and rightwards from the outer circumference of a lengthwise middle portion of the inner pipe so as to be embedded into the rubber part, the left bulge plate and the right bulge plate being disposed so as to be aligned with the front-left support and the front-right support in the longitudinal direction, and may further include an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the rear-upper support and the rear-lower support in the longitudinal direction.

According to the fourth embodiment of the present invention, the bulge part may include an upper bulge plate and a lower bulge plate protruding upwards and downwards from a front portion of the outer circumferential portion of the inner pipe so as to be in close contact with the front surface of the rubber part, the upper bulge plate and the lower bulge plate being disposed so as to be aligned with the rear-upper support and the rear-lower support in the longitudinal direction, and may further include a left bulge plate and a right bulge plate protruding leftwards and rightwards from a rear portion of the outer circumferential portion of the inner pipe so as to be in close contact with the rear surface of the rubber part, the left bulge plate and the right bulge plate being disposed so as to be aligned with the front-left support and the front-right support in the longitudinal direction.

According to the first embodiment of the present invention, front stoppers may protrude from the front surface of the rubber part at left and right positions so as to be in close contact with the front-left support and the front-right support, and rear stoppers may protrude from the rear surface of the rubber part at upper and lower positions so as to be in close contact with the rear-upper support and the rear-lower support.

According to the second embodiment of the present invention, the at least two supports may include a front-upper support and a front-lower support integrally formed with the front end of the outer pipe at upper and lower positions so as to be in close contact with the front surface of the rubber part to support the rubber part together with the bulge part so as to compress and expand the rubber part, and may further include a rear-upper support and a rear-lower support integrally formed with the rear end of the outer pipe at upper and lower positions so as to be in close contact with the rear surface of the rubber part to support the rubber part together with the bulge part so as to compress and expand the rubber part.

According to the second embodiment of the present invention, the bulge part may include an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the front-upper support, the front-lower support, the rear-upper support, and the rear-lower support in the longitudinal direction.

According to the second embodiment of the present invention, front stoppers may protrude from the front surface of the rubber part at upper and lower positions so as to be in close contact with the front-upper support and the front-lower support, and rear stoppers may protrude from the rear surface of the rubber part at upper and lower positions so as to be in close contact with the rear-upper support and the rear-lower support.

According to the third embodiment of the present invention, the at least two supports may include a front single support, integrally formed with the front end of the outer pipe at a lower position so as to be in close contact with the front surface of the rubber part to support the rubber part together with the bulge part so as to compress and expand the rubber part, and a rear single support, integrally formed with the rear end of the outer pipe at an upper position so as to be in close contact with the rear surface of the rubber part to support the rubber part together with the bulge part so as to compress and expand the rubber part.

According to the third embodiment of the present invention, the bulge part may include an upper bulge plate and a lower bulge plate protruding upwards and downwards from the outer circumference of a lengthwise middle portion of the inner pipe so as to be embedded into the rubber part, the lower bulge plate being disposed so as to be aligned with the front single support in the longitudinal direction, the upper bulge plate being disposed so as to be aligned with the rear single support in the longitudinal direction.

According to the fifth embodiment of the present invention, the bulge part may include an upper bulge plate protruding upwards from a front portion of the outer circumferential portion of the inner pipe so as to be in close contact with the front surface of the rubber part, the upper bulge plate being disposed so as to be aligned with the rear single support in the longitudinal direction, and a lower bulge plate protruding downwards from a rear portion of the outer circumferential portion of the inner pipe so as to be in close contact with the rear surface of the rubber part, the lower bulge plate being disposed so as to be aligned with the front single support in the longitudinal direction.

According to the third embodiment of the present invention, a front stopper may protrude from the front surface of the rubber part at a lower position so as to be in close contact with the front single support, and a rear stopper may protrude from the rear surface of the rubber part at an upper position so as to be in close contact with the rear single support.

According to each of the embodiments of the present invention, a slit having a V-shaped section may be formed in one side portion or in each of two opposite side portions of the outer pipe and the rubber part in the longitudinal direction thereof.

According to a sixth embodiment of the present invention for accomplishing the above and other objects, a bush-type mount for a vehicle may include an outer pipe fitted into a press-fit hole formed in a frame of a vehicle body in the longitudinal direction of the vehicle, an inner pipe having a bolt hole formed therein so as to be mounted to a PE part, the inner pipe being disposed inside the outer pipe so as to be oriented in the longitudinal direction, a rubber part formed in a vulcanization-molding process so as to fill the space between the outer pipe and the inner pipe, at least two supports integrally formed at the front end of the press-fit hole so as to be in close contact with the front surface of the rubber part and integrally formed with the rear end of the outer pipe so as to be in close contact with the rear surface of the rubber part, and a bulge part integrally formed with the outer circumferential portion of the inner pipe to compress or expand the rubber part in the same direction as the direction of movement of the inner pipe, the inner pipe being mounted so as to move in the longitudinal direction.

According to the sixth embodiment of the present invention, the at least two supports may include a front-left support and a front-right support attached to the front end of the press-fit hole at left and right positions so as to be in close contact with the front surface of the rubber part to support the rubber part together with the bulge part so as to compress and expand the rubber part, and may further include a rear-upper support and a rear-lower support integrally formed with the rear end of the outer pipe at upper and lower positions so as to be in close contact with the rear surface of the rubber part to support the rubber part together with the bulge part so as to compress and expand the rubber part.

According to the sixth embodiment of the present invention, the bulge part may include a left bulge plate and a right bulge plate protruding leftwards and rightwards from the outer circumference of a lengthwise middle portion of the inner pipe so as to be embedded into the rubber part, the left bulge plate and the right bulge plate being disposed so as to be aligned with the front-left support and the front-right support in the longitudinal direction, and may further include an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the rear-upper support and the rear-lower support in the longitudinal direction.

As a modification of the sixth embodiment of the present invention, in order to increase an extent of compression of the portion of the rubber part that is located between the bulge part, the front-left support, and the front-right support when the inner pipe moves forwards, the bulge part may be formed to be tilted backwards at a predetermined angle, and the front-left support and the front-right support may be formed to be tilted forwards at substantially the same angle as the angle of the bulge part.

As a modification of the sixth embodiment of the present invention, in order to reduce an extent of compression of the portion of the rubber part that is located between the bulge part, the front-left support, and the front-right support when the inner pipe moves forwards, the bulge part may be formed to be tilted forwards at a predetermined angle, and the front-left support and the front-right support may be formed to be tilted backwards at substantially the same angle as the angle of the bulge part.

As a modification of the sixth embodiment of the present invention, in order to adjust an extent of compression of the portion of the rubber part that is located between the bulge part, the front-left support, and the front-right support when the inner pipe moves forwards, the bulge part may be formed to be tilted forwards at a predetermined angle, and the front-left support and the front-right support may be formed to be tilted forwards at substantially the same angle as the angle of the bulge part.

As a modification of the sixth embodiment of the present invention, in order to adjust an extent of compression of the portion of the rubber part that is located between the bulge part, the front-left support, and the front-right support when the inner pipe moves forwards, the bulge part may be formed to be tilted backwards at a predetermined angle, and the front-left support and the front-right support may be formed to be tilted backwards at substantially the same angle as the angle of the bulge part.

According to the sixth embodiment of the present invention, front stoppers may protrude from the front surface of the rubber part at left and right positions so as to be in close contact with the front-left support and the front-right support, and rear stoppers may protrude from the rear surface of the rubber part at upper and lower positions so as to be in close contact with the rear-upper support and the rear-lower support.

According to the sixth embodiment of the present invention, the length that the front stoppers, which are in close contact with the front-left support and the front-right support, protrude may be set to be longer than the length that the rear stoppers protrude in order to maintain a state in which the rubber part is compressed to a predetermined extent in the axial direction by a preload.

According to seventh and eighth embodiments of the present invention for accomplishing the above and other objects, a bush-type mount for a vehicle may include an outer pipe, an inner pipe having a bolt hole formed therein so as to be mounted to a PE part, the inner pipe being disposed inside the outer pipe so as to be oriented in the longitudinal direction of the vehicle, a rubber part formed in a vulcanization-molding process so as to fill the space between the outer pipe and the inner pipe, a first separate outer pipe having at least two front supports formed so as to be in close contact with the front surface of the rubber part, the first separate outer pipe being press-fitted onto the front portion of the outer circumferential portion of the outer pipe, a second separate outer pipe having at least two rear supports formed so as to be in close contact with the rear surface of the rubber part, the second separate outer pipe being press-fitted onto the rear portion of the outer circumferential portion of the outer pipe, and a bulge part integrally formed with the outer circumferential portion of the inner pipe to compress or expand the rubber part in the same direction as the direction of movement of the inner pipe, the inner pipe being mounted so as to move in the longitudinal direction.

According to the seventh embodiment of the present invention, front stoppers may protrude from the front surface of the rubber part so as to be in close contact with the at least two front supports, and rear stoppers may protrude from the rear surface of the rubber part so as to be in close contact with the at least two rear supports.

According to the seventh embodiment of the present invention, the lengths that the front stoppers and the rear stoppers protrude may be set to lengths by which the rubber part is capable of being compressed by the at least two front supports and the at least two rear supports when the first separate outer pipe and the second separate outer pipe are fitted onto the outer circumferential portion of the outer pipe and come into contact with each other in order to maintain a state in which the rubber part is compressed to a predetermined extent in the axial direction by a preload.

According to the eighth embodiment of the present invention, the first separate outer pipe and the second separate outer pipe may be directly fitted onto the outer circumferential portion of the rubber part.

According to the eighth embodiment of the present invention, the outer diameter of the rubber part may be greater than the inner diameters of the first separate outer pipe and the second separate outer pipe in order to maintain a state in which the rubber part is compressed to a predetermined extent in the radial direction.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIGS. 1 and 2 are, respectively, a perspective view and a cross-sectional view of a conventional bush-type mount;

FIGS. 3 and 4 are views schematically showing the arrangement of conventional bush-type mounts mounted in a vehicle;

FIG. 5A is a perspective view of a bush-type mount according to a first embodiment of the present invention;

FIG. 5B is a front view of the bush-type mount according to the first embodiment of the present invention;

FIG. 5C is a rear view of the bush-type mount according to the first embodiment of the present invention;

FIG. 5D is a perspective view showing an example in which a bulge part is formed at an inner pipe of the bush-type mount according to the first embodiment of the present invention;

FIGS. 5E and 5F are cross-sectional views showing an example of operation of the bush-type mount according to the first embodiment of the present invention;

FIG. 6A is a perspective view of a bush-type mount according to a second embodiment of the present invention;

FIG. 6B is a front view of the bush-type mount according to the second embodiment of the present invention;

FIG. 6C is a rear view of the bush-type mount according to the second embodiment of the present invention;

FIG. 6D is a perspective view showing an example in which a bulge part is formed at an inner pipe of the bush-type mount according to the second embodiment of the present invention;

FIGS. 6E and 6F are cross-sectional views showing an example of operation of the bush-type mount according to the second embodiment of the present invention;

FIG. 7A is a perspective view of a bush-type mount according to a third embodiment of the present invention;

FIG. 7B is a front view of the bush-type mount according to the third embodiment of the present invention;

FIG. 7C is a rear view of the bush-type mount according to the third embodiment of the present invention;

FIG. 7D is a perspective view showing an example in which a bulge part is formed at an inner pipe of the bush-type mount according to the third embodiment of the present invention;

FIGS. 7E and 7F are cross-sectional views showing an example of operation of the bush-type mount according to the third embodiment of the present invention;

FIG. 8A is a perspective view of a bush-type mount according to a fourth embodiment of the present invention;

FIG. 8B is a front view of the bush-type mount according to the fourth embodiment of the present invention;

FIG. 8C is a rear view of the bush-type mount according to the fourth embodiment of the present invention;

FIG. 8D is a perspective view showing an example in which a bulge part is formed at an inner pipe of the bush-type mount according to the fourth embodiment of the present invention;

FIGS. 8E and 8F are cross-sectional views showing an example of operation of the bush-type mount according to the fourth embodiment of the present invention;

FIG. 9A is a perspective view of a bush-type mount according to a fifth embodiment of the present invention;

FIG. 9B is a front view of the bush-type mount according to the fifth embodiment of the present invention;

FIG. 9C is a rear view of the bush-type mount according to the fifth em bodiment of the present invention;

FIG. 9D is a perspective view showing an example in which a bulge part is formed at an inner pipe of the bush-type mount according to the fifth embodiment of the present invention;

FIGS. 9E and 9F are cross-sectional views showing an example of operation of the bush-type mount according to the fifth embodiment of the present invention;

FIGS. 10A to 10D are views showing examples in which a slit is formed in an outer pipe and a rubber part of the bush-type mount according to the first to fifth embodiments of the present invention;

FIG. 11A is a perspective view of a bush-type mount according to a sixth embodiment of the present invention;

FIG. 11B is a front view of the bush-type mount according to the sixth embodiment of the present invention;

FIG. 11C is a rear view of the bush-type mount according to the sixth embodiment of the present invention;

FIG. 11D is a perspective view showing an example in which a bulge part is formed at an inner pipe of the bush-type mount according to the sixth embodiment of the present invention;

FIGS. 11E and 11F are cross-sectional views showing an example of operation of the bush-type mount according to the sixth embodiment of the present invention;

FIG. 11G is a cross-sectional view showing the state in which a rubber part is compressed to a predetermined extent in an axial direction by a preload due to an increase in the length that a front stopper protrudes in the bush-type mount according to the sixth embodiment of the present invention;

FIGS. 12A to 12F are cross-sectional views showing modifications of the bush-type mount according to the sixth embodiment of the present invention;

FIG. 13A is an exploded perspective view showing a bush-type mount according to a seventh embodiment of the present invention;

FIG. 13B is a perspective view showing the assembled state of the bush-type mount according to the seventh embodiment of the present invention;

FIGS. 13C and 13D are cross-sectional views showing the bush-type mount according to the seventh embodiment of the present invention;

FIG. 14A is an exploded perspective view showing a bush-type mount according to an eighth embodiment of the present invention;

FIG. 14B is a perspective view showing the assembled state of the bush-type mount according to the eighth embodiment of the present invention; and

FIGS. 14C and 14D are cross-sectional views showing the bush-type mount according to the eighth embodiment of the present invention.

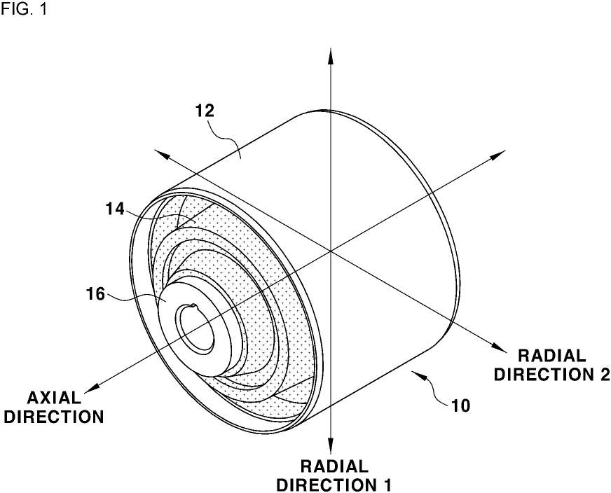

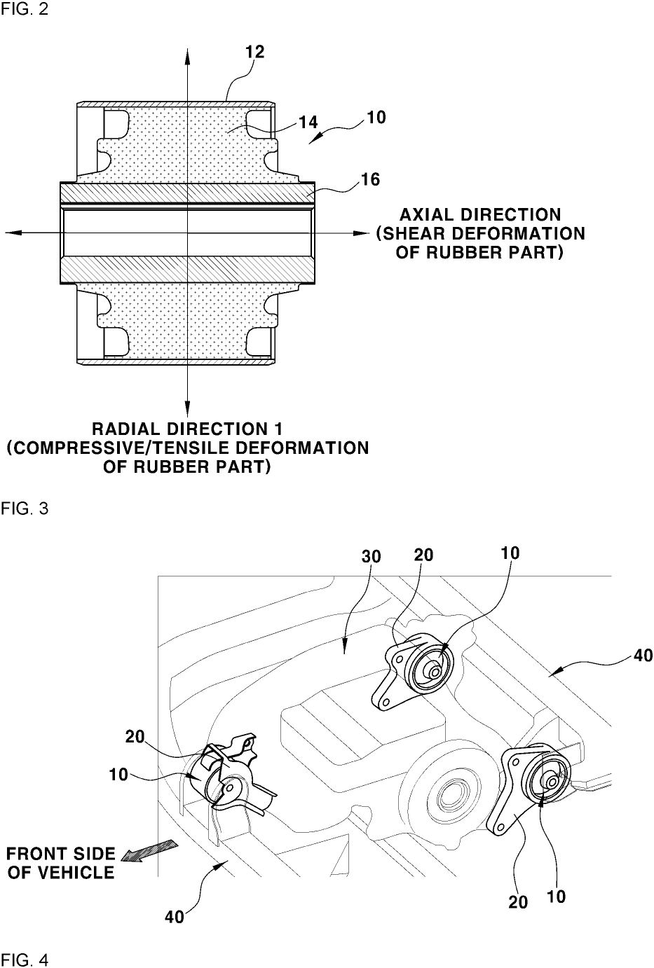

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Hereinafter, reference will now be made in detail to various embodiments of the present invention, examples of which are illustrated in the accompanying drawings and described below.

### First Embodiment

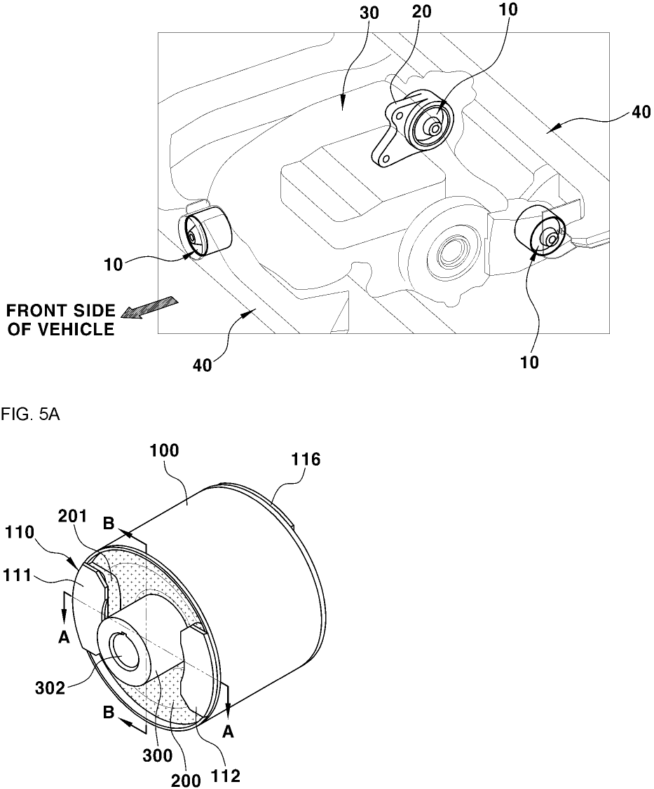

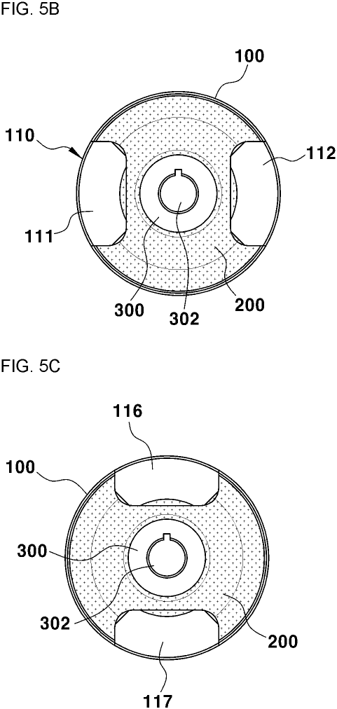

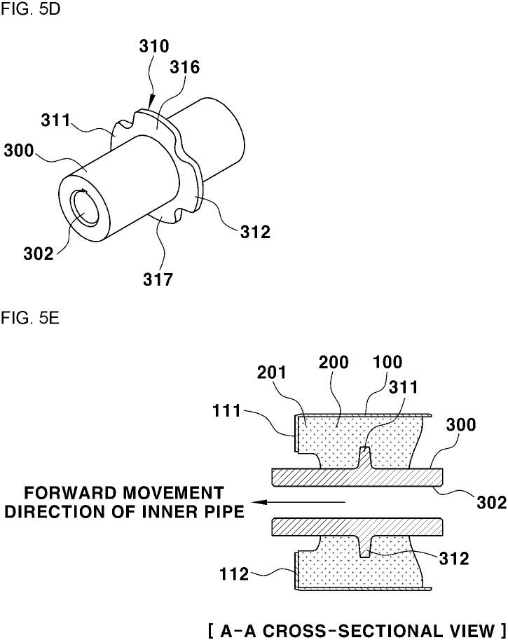

FIGS. 5A to 5C show the assembled state of a bush-type mount according to a first embodiment of the present invention, FIG. 5D shows an example in which a bulge part is formed at an inner pipe of the bush-type mount according to the first embodiment of the present invention, and FIGS. 5E and 5F are cross-sectional views showing an example of operation of the bush-type mount according to the first embodiment of the present invention.

The bush-type mount according to the first embodiment of the present invention basically includes an outer pipe 100, which is fitted into a press-fit hole formed in a frame of a vehicle body in the longitudinal direction of a vehicle, an inner pipe 300, which has a bolt hole 302 formed therein so as to be mounted to a PE part and is disposed inside the outer pipe 100 so as to be oriented in the longitudinal direction, and a rubber part 200, which is formed in a vulcanization-molding process so as to fill the space between the inner circumferential portion of the outer pipe 100 and the outer circumferential portion of the inner pipe 300.

At least two supports 110 are formed at the front and rear ends of the outer pipe 100 so as to be in close contact with the front and rear surfaces of the rubber part 200. The supports 110 may be integrally formed with the front and rear ends of the outer pipe 100, or may be attached thereto through welding or the like so as to extend toward the rubber part 200.

In addition, a bulge part 310 is integrally formed with the outer circumferential portion of the inner pipe 300 so as to be aligned with the supports 110 in the longitudinal direction of the vehicle. The bulge part 310 functions to compress or expand the rubber part 200 in the same direction as the direction of movement of the inner pipe 300, which moves in the longitudinal direction of the vehicle.

According to the first embodiment of the present invention, as shown in FIGS. 5A to 5C, the supports 110 may include a front-left support 111 and a front-right support 112, which are integrally formedwith the front end of the outer pipe 100 at left and right positions so as to be in close contact with the front surface of the rubber part 200 and support the rubber part 200 together with the bulge part 310 so as to compress and expand the rubber part 200, and may further include a rear-upper support 116 and a rear-lower support 117, which are integrally formed with the rear end of the outer pipe 100 at upper and lower positions so as to be in close contact with the rear surface of the rubber part 200 and support the rubber part 200 together with the bulge part 310 so as to compress and expand the rubber part 200.

Each of the front-left support 111, the front-right support 112, the rear-upper support 116, and the rear-lower support 117 may be formed in the shape of a plate, and may be made of the same metal material as that of the outer pipe 100. The supports 111, 112, 116, and 117 may be bent and extend from the outer pipe 100 toward the front and rear surfaces of the rubber part 200 in a direction perpendicular to the longitudinal direction of the outer pipe 100.

According to the first embodiment of the present invention, as shown in FIG. 5D, the bulge part 310 may include a left bulge plate 311 and a right bulge plate 312, which protrude leftwards and rightwards from the outer circumference of a lengthwise middle portion of the inner pipe 300 so as to be embedded into the rubber part 200 and are disposed so as to be aligned with the front-left support 111 and the front-right support 112 in the longitudinal direction, and may further include an upper bulge plate 316 and a lower bulge plate 317, which protrude upwards and downwards from the outer circumference of a lengthwise middle portion of the inner pipe 300 so as to be embedded into the rubber part 200 and are disposed so as to be aligned with the rear-upper support 116 and the rear-lower support 117 in the longitudinal direction.

According to the first embodiment of the present invention, front stoppers 201 protrude from the front surface of the rubber part 200 at left and right positions so as to be in close contact with the front-left support 111 and the front-right support 112, and rear stoppers 202 protrude from the rear surface of the rubber part 200 at upper and lower positions so as to be in close contact with the rear-upper support 116 and the rear-lower support 117.

Depending on how the supports 111, 112, 116, and 117 are configured, the protruding lengths of the front stoppers 201 and the rear stoppers 202 may be set differently, and a preload may be applied to the front stoppers 201 and the rear stoppers 202.

For example, if the rubber part 200 is formed in a vulcanization-molding process such that the front stoppers 201 and the rear stoppers 202 protrude further than the outer pipe 100 and thereafter the supports 111, 112, 116, and 117 are formed so as to extend from the outer pipe 100 toward the front and rear surfaces of the rubber part 200, the front stoppers 201 and the rear stoppers 202 are compressed while receiving a preload.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the first embodiment of the present invention is disposed in the longitudinal direction of the vehicle.

Hereinafter, the operation of the bush-type mount according to the first embodiment of the present invention will be described.

As shown in FIG. 5E, when the inner pipe 300 moves toward the front side of the vehicle due to acceleration/deceleration shock of the vehicle or external impacts such as vibrations transferred from the road, the portion of the rubber part 200 that is located between the front-left and front-right supports 111 and 112 of the supports 110 and the left and right bulge plates 311 and 312 of the bulge part 310 is compressed in the axial direction (the longitudinal direction), whereby the axial property (stiffness) of the rubber part 200 may increase.

Also, as shown in FIG. 5F, when the inner pipe 300 moves toward the rear side of the vehicle due to acceleration/deceleration shock of the vehicle or external impacts such as vibrations transferred from the road, the portion of the rubber part 200 that is located between the rear-upper and rear-lower supports 116 and 117 of the supports 110 and the upper and lower bulge plates 316 and 317 of the bulge part 310 is compressed in the axial direction (the longitudinal direction), whereby the axial property (stiffness) of the rubber part 200 may increase.

As described above with reference to FIG. 4, in the case in which one bush-type mount is mounted at a relatively forward position such that the axial direction thereof is parallel to the longitudinal direction of the vehicle and two bush-type mounts are mounted at two relatively rearward positions such that the axial directions thereof are parallel to the lateral direction of the vehicle, the property of the entire mount system in the axial direction (the property in the longitudinal direction of the vehicle) is lowered because each of the bush-type mounts is formed such that the axial property thereof is set to be lower than the radial property thereof, thus failing to appropriately respond to impacts and aftershock and accordingly deteriorating driving performance. However, since the bush-type mount according to the first embodiment of the present invention exhibits a high axial property, it is possible to solve the problem of deterioration in driving performance due to external impacts and aftershock.

As described above, according to the first embodiment of the present invention, when the inner pipe 300 moves relative to the outer pipe 100 in the axial direction, the rubber part 200 undergoes compressive or tensile deformation, rather than shear deformation, thus making it possible to increase freedom of adjustment of the axial property of the bush-type mount.

### Second Embodiment

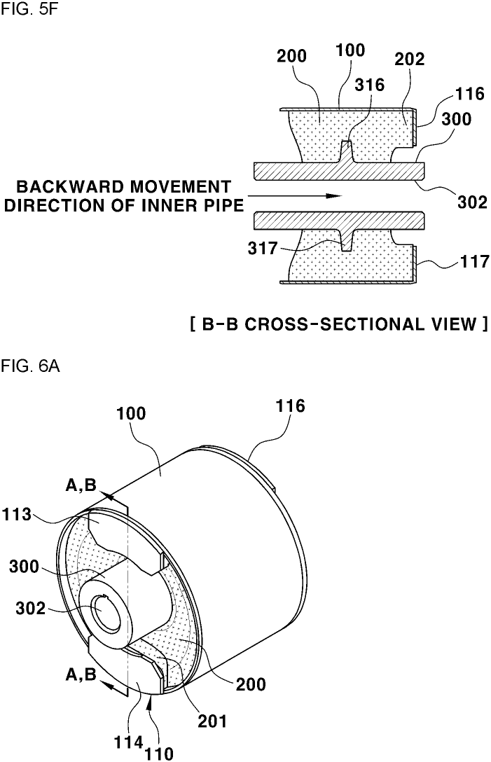

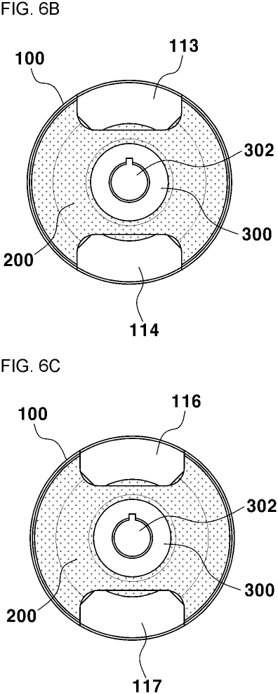

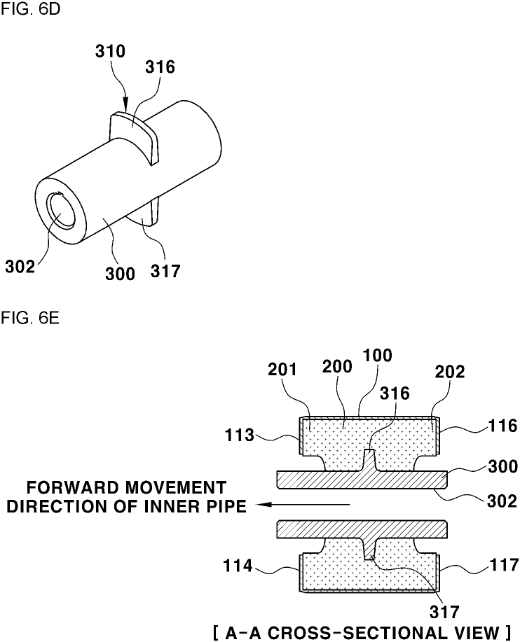

FIGS. 6A to 6C show the assembled state of a bush-type mount according to a second embodiment of the present invention, FIG. 6D shows an example in which a bulge part is formed at an inner pipe of the bush-type mount according to the second embodiment of the present invention, and FIGS. 6E and 6F are cross-sectional views showing an example of operation of the bush-type mount according to the second embodiment of the present invention.

The bush-type mount according to the second embodiment of the present invention basically includes an outer pipe 100, which is fitted into the press-fit hole formed in the frame of a vehicle body in the longitudinal direction of the vehicle, an inner pipe 300, which has a bolt hole 302 formed therein so as to be mounted to the PE part and is disposed inside the outer pipe 100 so as to be oriented in the longitudinal direction, and a rubber part 200, which is formed in a vulcanization-molding process so as to fill the space between the inner circumferential portion of the outer pipe 100 and the outer circumferential portion of the inner pipe 300. Compared to the above-described first embodiment, the second embodiment has a difference with regard to the structure of supports 110 formed at the front and rear ends of the outer pipe 100 and the structure of a bulge part 310 formed on the outer circumferential portion of the inner pipe 300.

According to the second embodiment of the present invention, as shown in FIGS. 6A to 6C, the supports 110 may include a front-upper support 113 and a front-lower support 114, which are integrally formed with the front end of the outer pipe 100 at upper and lower positions so as to be in close contact with the front surface of the rubber part 200 and support the rubber part 200 together with the bulge part 310 so as to compress and expand the rubber part 200, and may further include a rear-upper support 116 and a rear-lower support 117, which are integrally formed with the rear end of the outer pipe 100 at upper and lower positions so as to be in close contact with the rear surface of the rubber part 200 and support the rubber part 200 together with the bulge part 310 so as to compress and expand the rubber part 200.

According to the second embodiment of the present invention, as shown in FIG. 6D, the bulge part 310 may include an upper bulge plate 316 and a lower bulge plate 317, which protrude upwards and downwards from the outer circumference of a lengthwise middle portion of the inner pipe 300 so as to be embedded into the rubber part 200 and are disposed so as to be aligned with the front-upper and front-lower supports 113 and 114 and the rear-upper and rear-lower supports 116 and 117 in the longitudinal direction.

According to the second embodiment of the present invention, front stoppers 201 protrude from the front surface of the rubber part 200 at upper and lower positions so as to be in close contact with the front-upper support 113 and the front-lower support 114, and rear stoppers 202 protrude from the rear surface of the rubber part 200 at upper and lower positions so as to be in close contact with the rear-upper support 116 and the rear-lower support 117.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the second embodiment of the present invention is disposed in the longitudinal direction of the vehicle.

Hereinafter, the operation of the bush-type mount according to the second embodiment of the present invention will be described.

As shown in FIG. 6E, when the inner pipe 300 moves toward the front side of the vehicle due to acceleration/deceleration shock of the vehicle or external impacts such as vibrations transferred from the road, the portion of the rubber part 200 that is located between the front-upper and front-lower supports 113 and 114 of the supports 110 and the upper and lower bulge plates 316 and 317 of the bulge part 310 is compressed in the axial direction (the longitudinal direction), and at the same time, the portion of the rubber part 200 that is located between the rear-upper and rear-lower supports 116 and 117 of the supports 110 and the upper and lower bulge plates 316 and 317 of the bulge part 310 is expanded in the axial direction, whereby the axial property (stiffness) of the rubber part 200 may become higher than that in the above-described first embodiment.

Also, as shown in FIG. 6F, when the inner pipe 300 moves toward the rear side of the vehicle due to acceleration/deceleration shock of the vehicle or external impacts such as vibrations transferred from the road, the portion of the rubber part 200 that is located between the rear-upper and rear-lower supports 116 and 117 of the supports 110 and the upper and lower bulge plates 316 and 317 of the bulge part 310 is compressed in the axial direction (the longitudinal direction), and at the same time, the portion of the rubber part 200 that is located between the front-upper and front-lower supports 113 and 114 of the supports 110 and the upper and lower bulge plates 316 and 317 of the bulge part 310 is expanded in the axial direction, whereby the axial property of the rubber part 200 may become higher than that in the above-described first embodiment.

As described above, according to the second embodiment of the present invention, when the inner pipe 300 moves forwards and backwards, compression and expansion occur simultaneously in the rubber part 200 along the same axis, thus making the axial property of the rubber part 200 higher than that in the above-described first embodiment.

Accordingly, the bush-type mount according to the second embodiment of the present invention, which exhibits a high axial property, is capable of solving the above-described problem associated with the conventional bush-type mount, which has a low axial property and thus fails to appropriately respond to impacts and aftershock and causes deterioration in driving performance.

### Third Embodiment

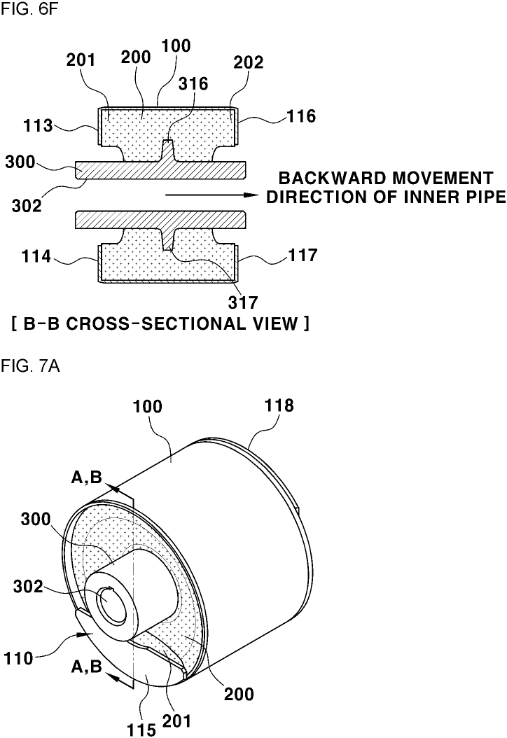

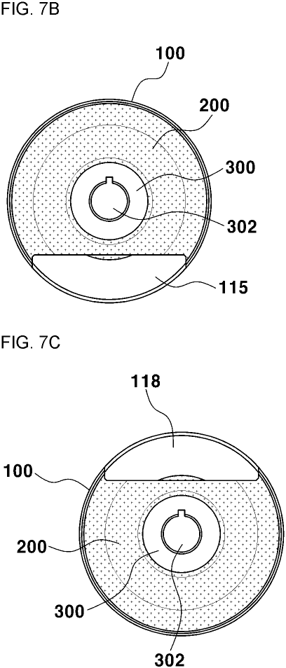

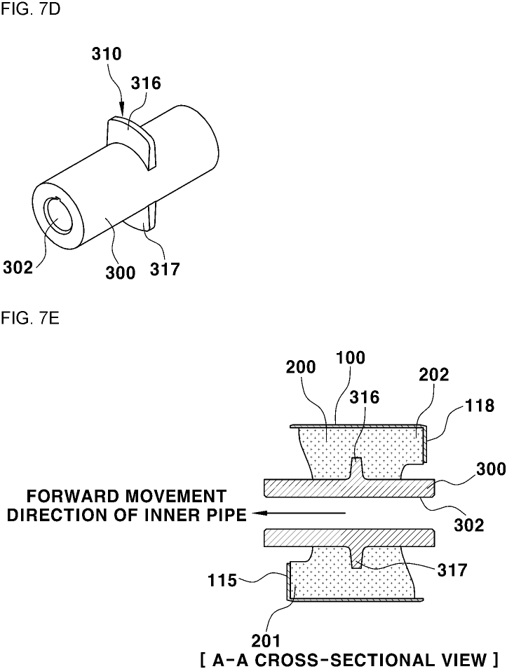

FIGS. 7A to 7C show the assembled state of a bush-type mount according to a third embodiment of the present invention, FIG. 7D shows an example in which a bulge part is formed at an inner pipe of the bush-type mount according to the third embodiment of the present invention, and FIGS. 7E and 7F are cross-sectional views showing an example of operation of the bush-type mount according to the third embodiment of the present invention.

The bush-type mount according to the third embodiment of the present invention is characterized by maximizing the areas of supports 110 formed at the outer pipe 100 while minimizing the number of supports 110 in order to facilitate assembly and manufacture of the bush-type mount.

To this end, as shown in FIGS. 7A to 7C, the supports 110 according to the third embodiment of the present invention may include a front single support 115, which is integrally formed with the front end of the outer pipe 100 at a lower position so as to be in close contact with the front surface of the rubber part 200 and supports the rubber part 200 together with the bulge part 310 so as to compress and expand the rubber part 200, and a rear single support 118, which is integrally formed with the rear end of the outer pipe 100 at an upper position so as to be in close contact with the rear surface of the rubber part 200 and supports the rubber part 200 together with the bulge part 310 so as to compress and expand the rubber part 200.

In this case, the front single support 115 and the rear single support 118 of the supports 110 are integrally formed with the front end and the rear end of the outer pipe 100 so as to have maximum areas within a range within which interference with the inner pipe 300 is avoided.

According to the third embodiment of the present invention, as shown in FIG. 7D, the bulge part 310 may include an upper bulge plate 316 and a lower bulge plate 317, which protrude upwards and downwards from the outer circumference of a lengthwise middle portion of the inner pipe 300 so as to be embedded into the rubber part 200. The lower bulge plate 317 is disposed so as to be aligned with the front single support 115 in the longitudinal direction, and the upper bulge plate 316 is disposed so as to be aligned with the rear single support 118 in the longitudinal direction.

In this case, in order to facilitate compression of the rubber part 200, it is desirable to maximize the areas of the lower bulge plate 317 and the upper bulge plate 316 so as to correspond to the maximized areas of the front single support 115 and the rear single support 118.

According to the third embodiment of the present invention, a front stopper 201 protrudes from the front surface of the rubber part 200 at a lower position so as to be in close contact with the front single support 115, and a rear stopper 202 protrudes from the rear surface of the rubber part 200 at an upper position so as to be in close contact with the rear single support 118.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the third embodiment of the present invention is disposed in the longitudinal direction of the vehicle.

Hereinafter, the operation of the bush-type mount according to the third embodiment of the present invention will be described.

As shown in FIG. 7E, when the inner pipe 300 moves toward the front side of the vehicle due to acceleration/deceleration shock of the vehicle or external impacts such as vibrations transferred from the road, the portion of the rubber part 200 that is located between the front single support 115 of the supports 110 and the lower bulge plate 317 of the bulge part 310 is compressed in the axial direction (the longitudinal direction), whereby the axial property (stiffness) of the rubber part 200 may be increased.

Also, as shown in FIG. 7F, when the inner pipe 300 moves toward the rear side of the vehicle due to acceleration/deceleration shock of the vehicle or external impacts such as vibrations transferred from the road, the portion of the rubber part 200 that is located between the rear single support 118 of the supports 110 and the upper bulge plate 316 of the bulge part 310 is compressed in the axial direction, whereby the axial property of the rubber part 200 may be increased.

Accordingly, the bush-type mount according to the third embodiment of the present invention, which exhibits a high axial property, is capable of solving the above-described problem associated with the conventional bush-type mount, which has a low axial property and thus fails to appropriately respond to impacts and aftershock and causes deterioration in driving performance.

As described above, according to the third embodiment of the present invention, the number of supports 110 is minimized while the areas thereof are maximized, and accordingly, assembly and manufacture of the bush-type mount may be more easily realized than in the case of the first and second embodiments. Also, the rubber part 200 undergoes compressive or tensile deformation, rather than shear deformation, thus making it possible to increase freedom of adjustment of the axial property of the bush-type mount.

### Fourth Embodiment

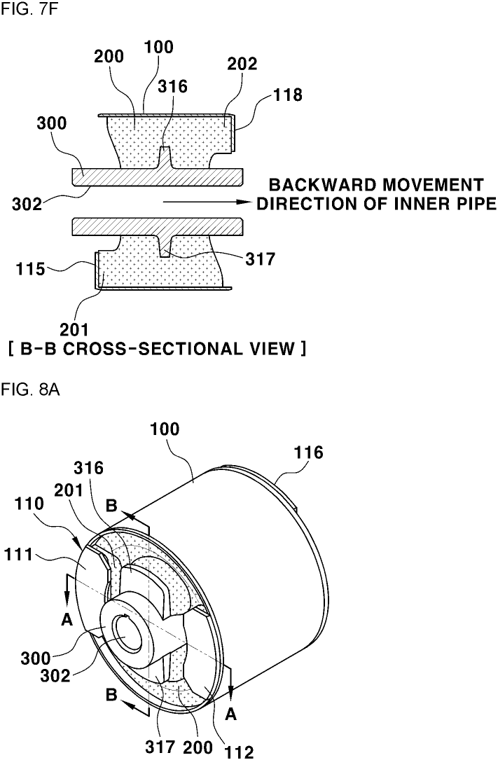

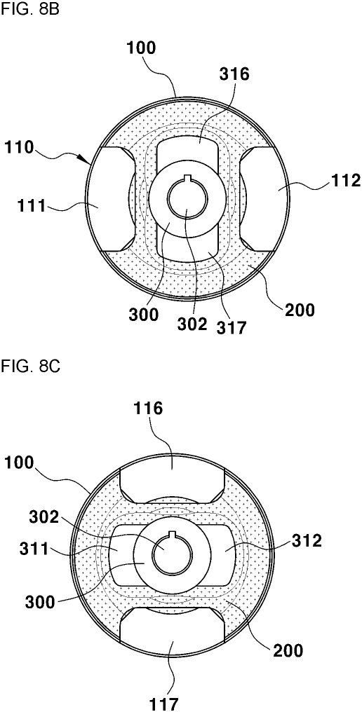

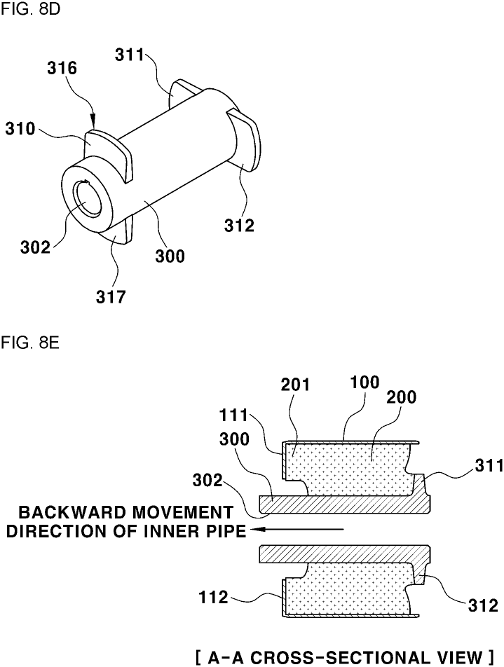

FIGS. 8A to 8C show the assembled state of a bush-type mount according to a fourth embodiment of the present invention, FIG. 8D shows an example in which a bulge part is formed at an inner pipe of the bush-type mount according to the fourth embodiment of the present invention, and FIGS. 8E and 8F are cross-sectional views showing an example of operation of the bush-type mount according to the fourth embodiment of the present invention.

The bush-type mount according to the fourth embodiment of the present invention has a configuration similar to that of the first embodiment, and is characterized in that the bulge part 310 formed at the inner pipe 300 is in close contact with the front and rear surfaces of the rubber part 200.

Similar to the first embodiment, according to the fourth embodiment of the present invention, as shown in FIGS. 8A to 8C, the supports 110 may include a front-left support 111 and a front-right support 112, which are integrally formed with the front end of the outer pipe 100 at left and right positions so as to be in close contact with the front surface of the rubber part 200 and support the rubber part 200 together with the bulge part 310 so as to compress and expand the rubber part 200, and may further include a rear-upper support 116 and a rear-lower support 117, which are integrally formed with the rear end of the outer pipe 100 at upper and lower positions so as to be in close contact with the rear surface of the rubber part 200 and support the rubber part 200 together with the bulge part 310 so as to compress and expand the rubber part 200.

Also, according to the fourth embodiment of the present invention, as shown in FIGS. 8A to 8D, the bulge part 310 may include an upper bulge plate 316 and a lower bulge plate 317, which protrude upwards and downwards from the front portion of the outer circumferential portion of the inner pipe 300 so as to be in close contact with the front surface of the rubber part 200 and are disposed so as to be aligned with the rear-upper support 116 and the rear-lower support 117 in the longitudinal direction, and may further include a left bulge plate 311 and a right bulge plate 312, which protrude leftwards and rightwards from the rear portion of the outer circumferential portion of the inner pipe 300 so as to be in close contact with the rear surface of the rubber part 200 and are disposed so as to be aligned with the front-left support 111 and the front-right support 112 in the longitudinal direction.

According to the fourth embodiment of the present invention, front stoppers 201 protrude from the front surface of the rubber part 200 at left and right positions so as to be in close contact with the front-left support 111 and the front-right support 112, and rear stoppers 202 protrude from the rear surface of the rubber part 200 at upper and lower positions so as to be in close contact with the rear-upper support 116 and the rear-lower support 117.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the fourth embodiment of the present invention is disposed in the longitudinal direction of the vehicle.

As described above, according to the fourth embodiment of the present invention, since the bulge part 310 is formed so as to be in close contact with the front and rear surfaces of the rubber part 200, rather than being embedded into the rubber part 200, it is possible to maximize the initial length before compression of the rubber part 200, thereby providing freedom of adjustment of the axial property and the radial property of the rubber part.

Hereinafter, the operation of the bush-type mount according to the fourth embodiment of the present invention will be described.

As shown in FIG. 8E, when the inner pipe 300 moves toward the front side of the vehicle due to acceleration/deceleration shock of the vehicle or external impacts such as vibrations transferred from the road, the portion of the rubber part 200 that is located between the front-left and front-right supports 111 and 112 of the supports 110 and the left and right bulge plates 311 and 312 of the bulge part 310 is compressed in the axial direction (the longitudinal direction), whereby the axial property (stiffness) of the rubber part 200 may increase.

Also, as shown in FIG. 8F, when the inner pipe 300 moves toward the rear side of the vehicle due to acceleration/deceleration shock of the vehicle or external impacts such as vibrations transferred from the road, the portion of the rubber part 200 that is located between the rear-upper and rear-lower supports 116 and 117 of the supports 110 and the upper and lower bulge plates 316 and 317 of the bulge part 310 is compressed in the axial direction (the longitudinal direction), whereby the axial property of the rubber part 200 may increase.

Accordingly, the bush-type mount according to the fourth embodiment of the present invention, which exhibits a high axial property, is capable of solving the above-described problem associated with the conventional bush-type mount, which has a low axial property and thus fails to appropriately respond to impacts and aftershock and causes deterioration in driving performance.

As described above, according to the fourth embodiment of the present invention, when the inner pipe 300 moves relative to the outer pipe 100 in the axial direction, the rubber part 200 undergoes compressive deformation, rather than shear deformation, thus making it possible to increase the axial property of the bush-type mount. Also, since the bulge part 310 is formed so as to be in close contact with the front and rear surfaces of the rubber part 200, rather than being embedded into the rubber part 200, it is possible to maximize the initial length before compression of the rubber part 200, thereby providing freedom of adjustment of the axial property and the radial property of the rubber part.

### Fifth Embodiment

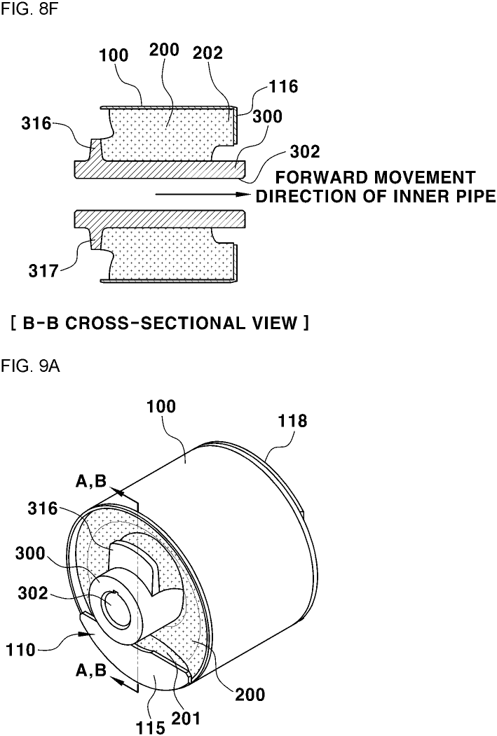

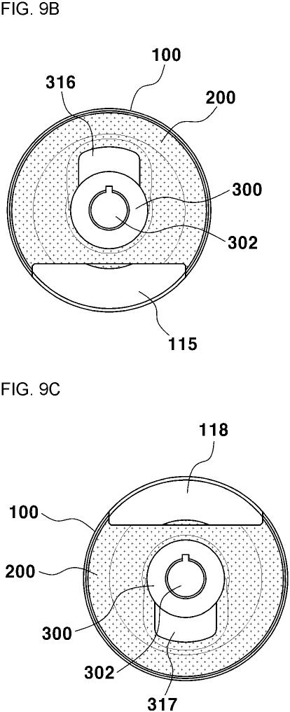

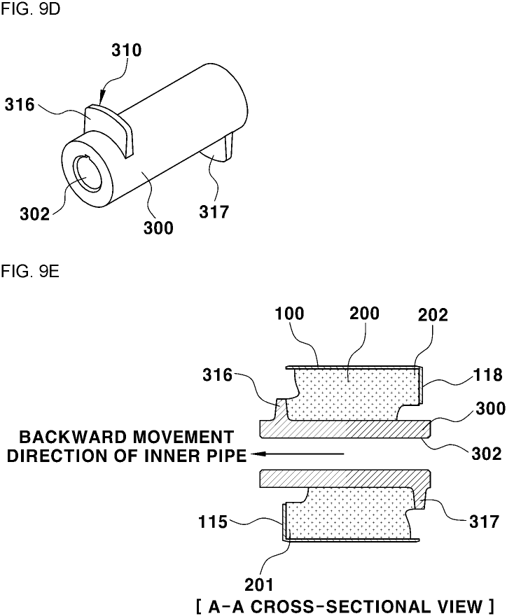

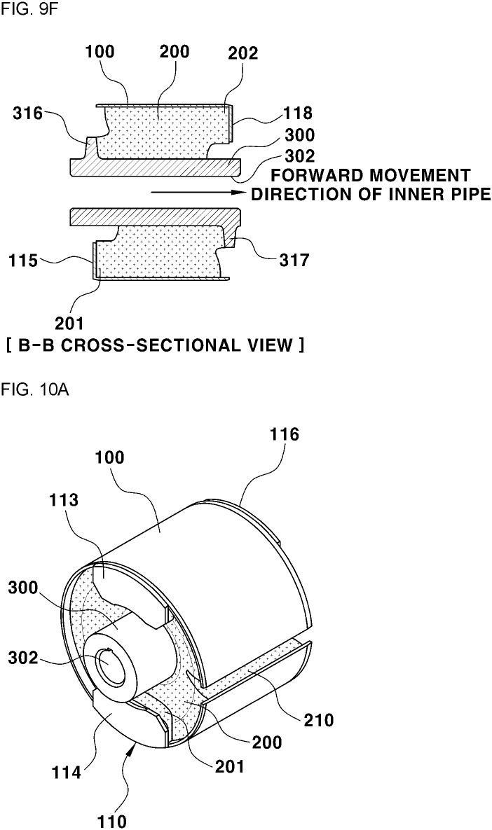

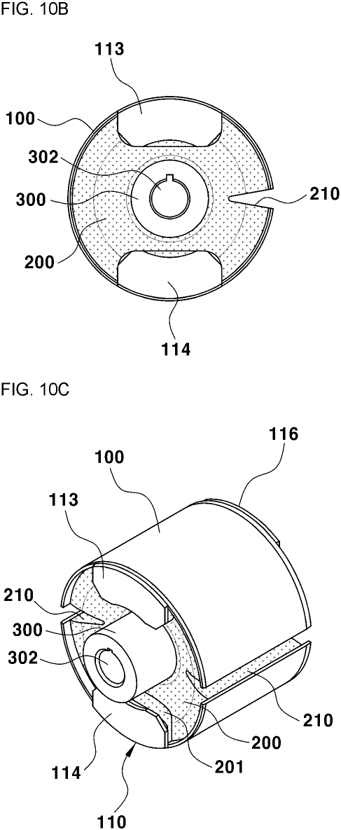

FIGS. 9A to 9C show the assembled state of a bush-type mount according to a fifth embodiment of the present invention, FIG. 9D shows an example in which a bulge part is formed at an inner pipe of the bush-type mount according to the fifth embodiment of the present invention, and FIGS. 9E and 9F are cross-sectional views showing an example of operation of the bush-type mount according to the fifth embodiment of the present invention.

The bush-type mount according to the fifth embodiment of the present invention has a configuration similar to that of the third embodiment, and is characterized in that the bulge part 310 formed at the inner pipe 300 is in close contact with the front and rear surfaces of the rubber part 200.

Similar to the third embodiment, according to the fifth embodiment of the present invention, as shown in FIGS. 9A to 9C, the supports 110 may include a front single support 115, which is integrally formed with the front end of the outer pipe 100 at a lower position so as to be in close contact with the front surface of the rubber part 200 and supports the rubber part 200 together with the bulge part 310 so as to compress and expand the rubber part 200, and a rear single support 118, which is integrally formed with the rear end of the outer pipe 100 at an upper position so as to be in close contact with the rear surface of the rubber part 200 and supports the rubber part 200 together with the bulge part 310 so as to compress and expand the rubber part 200.

Also, according to the fifth embodiment of the present invention, as shown in FIG. 9D, the bulge part 310 may include an upper bulge plate 316, which protrudes upwards from the front portion of the outer circumferential portion of the inner pipe 300 so as to be in close contact with the front surface of the rubber part 200 and is disposed so as to be aligned with the rear single support 118 in the longitudinal direction, and a lower bulge plate 317, which protrudes downwards from the rear portion of the outer circumferential portion of the inner pipe 300 so as to be in close contact with the rear surface of the rubber part 200 and is disposed so as to be aligned with the front single support 115 in the longitudinal direction.

According to the fifth embodiment of the present invention, a front stopper 201 protrudes from the front surface of the rubber part 200 at a lower position so as to be in close contact with the front single support 115, and a rear stopper 202 protrudes from the rear surface of the rubber part 200 at an upper position so as to be in close contact with the rear single support 118.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the fifth embodiment of the present invention is disposed in the longitudinal direction of the vehicle.

Particularly, according to the fifth embodiment of the present invention, since the bulge part 310 is formed so as to be in close contact with the front and rear surfaces of the rubber part 200, rather than being embedded into the rubber part 200, it is possible to maximize the initial length before compression of the rubber part 200, thereby providing freedom of adjustment of the axial property and the radial property of the rubber part.

Hereinafter, the operation of the bush-type mount according to the fifth embodiment of the present invention will be described.

As shown in FIG. 9E, when the inner pipe 300 moves toward the front side of the vehicle due to acceleration/deceleration shock of the vehicle or external impacts such as vibrations transferred from the road, the portion of the rubber part 200 that is located between the front single support 115 of the supports 110 and the lower bulge plate 317 of the bulge part 310 is compressed in the axial direction (the longitudinal direction), whereby the axial property (stiffness) of the rubber part 200 may increase.

Also, as shown in FIG. 9F, when the inner pipe 300 moves toward the rear side of the vehicle due to acceleration/deceleration shock of the vehicle or external impacts such as vibrations transferred from the road, the portion of the rubber part 200 that is located between the rear single support 118 of the supports 110 and the upper bulge plate 316 of the bulge part 310 is compressed in the axial direction, whereby the axial property of the rubber part 200 may increase.

Accordingly, the bush-type mount according to the fifth embodiment of the present invention, which exhibits a high axial property, is capable of solving the above-described problem associated with the conventional bush-type mount, which has a low axial property and thus fails to appropriately respond to impacts and aftershock and causes deterioration in driving performance.

As described above, according to the fifth embodiment of the present invention, the number of supports 110 is minimized while the areas thereof are maximized, and accordingly, assembly and manufacture of the bush-type mount may be more easily realized than in the case of the first and second embodiments. Also, since the bulge part 310 is formed so as to be in close contact with the front and rear surfaces of the rubber part 200, rather than being em bedded into the rubber part 200, it is possible to maximize the initial length before compression of the rubber part 200, thereby providing freedom of adjustment of the axial property and the radial property of the rubber part.

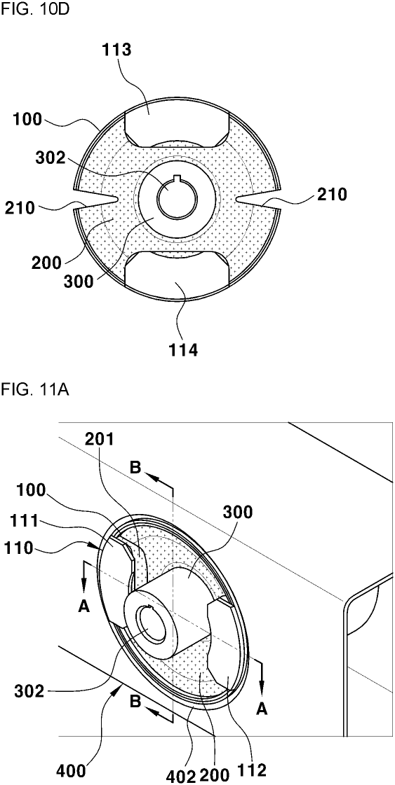

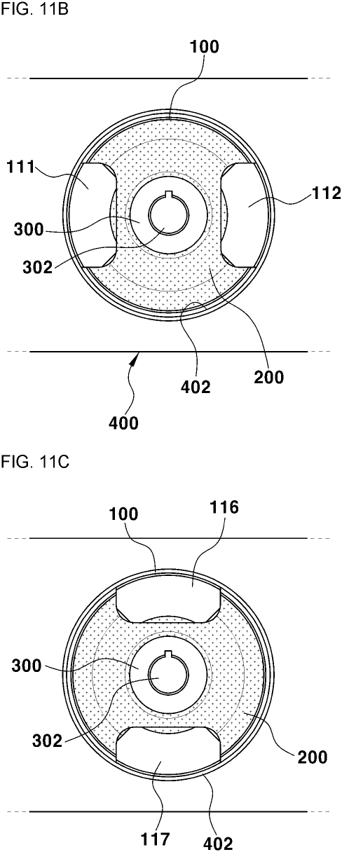

In addition, as shown in FIGS. 10A and 10B, in the bush-type mount according to each of the embodiments of the present invention, a slit 210 having a V-shaped section may be formed in the outer pipe 100 and the rubber part 200 in the longitudinal direction thereof. Alternatively, as shown in FIGS. 10C and 10D, slits 210, each of which has a V-shaped section, may be formed in the outer pipe 100 and the rubber part 200 in the longitudinal direction thereof at two opposite positions.

Accordingly, when swaging is performed in order to press the outer circumferential portion of the outer pipe 100, the inner surfaces of the slit 210 having a V-shaped section come into contact with each other, whereby the outer pipe 100 is easily formed in the shape of a perfect circle. Thus, it is possible to prevent the outer pipe from being undesirably deformed or damaged when swaging is performed in order to form the outer pipe in a perfectly circular shape.

In the state in which the inner surfaces of the slit 210 having a V-shaped section are in contact with each other, the outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to each of the above-described embodiments is disposed in the longitudinal direction of the vehicle.

In addition, when the outer pipe 100 is press-fitted into the press-fit hole formed in the frame of the vehicle body in the longitudinal direction of the vehicle, the inner surfaces of the slit 210 having a V-shaped section come into contact with each other, and thus the rubber part 200 is continuously maintained in a radially compressed state by a preload. Accordingly, it is possible to increase the radial property of the rubber part, and as a result, it is possible to provide freedom of adjustment of the properties of the bush-type mount according to each of the above-described embodiments along three axes (in the axial direction, the vertical radial direction, and the lateral radial direction).

### Sixth Embodiment

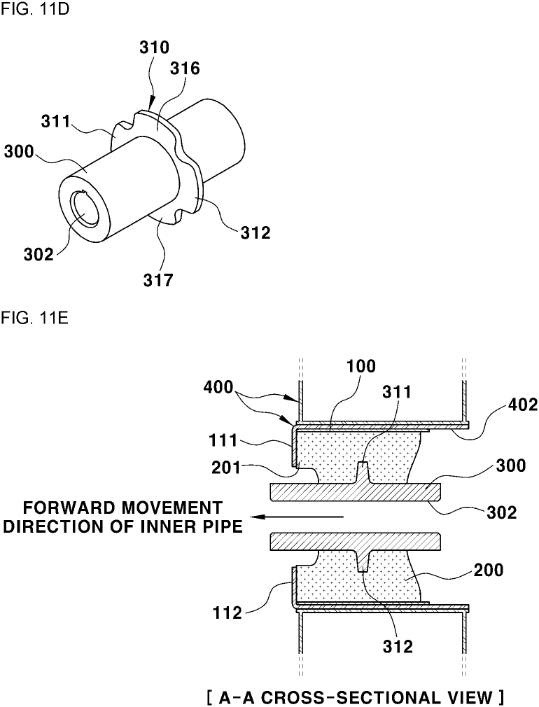

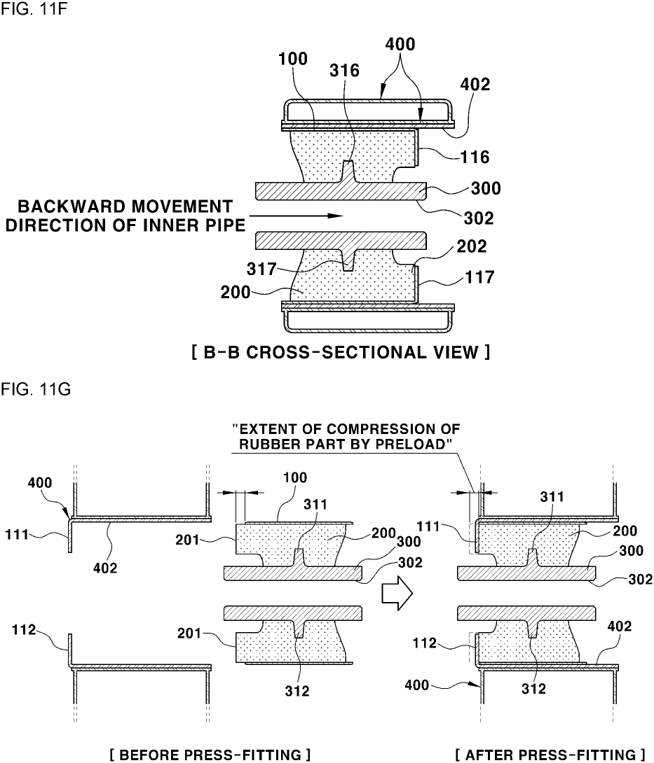

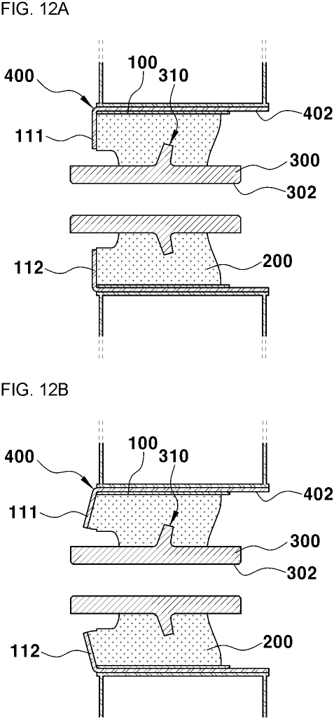

FIGS. 11A to 11C show the assembled state of a bush-type mount according to a sixth embodiment of the present invention, FIG. 11D shows an example in which a bulge part is formed at an inner pipe of the bush-type mount according to the sixth embodiment of the present invention, FIGS. 11E and 11F are cross-sectional views showing an example of operation of the bush-type mount according to the sixth embodiment of the present invention, and FIG. 11G is a cross-sectional view showing the state in which a rubber part is compressed to a predetermined extent in the axial direction by a preload due to an increase in the length that a front stopper protrudes in the bush-type mount according to the sixth embodiment of the present invention.

The bush-type mount according to the sixth embodiment of the present invention basically includes an outer pipe 100, which is fitted into a press-fit hole 402 formed in a frame 400 of the vehicle body in the longitudinal direction of the vehicle, an inner pipe 300, which has a bolt hole 302 formed therein so as to be mounted to a PE part and is disposed inside the outer pipe 100 so as to be oriented in the longitudinal direction, and a rubber part 200, which is formed in a vulcanization-molding process so as to fill the space between the inner circumferential portion of the outer pipe 100 and the outer circumferential portion of the inner pipe 300.

The bush-type mount according to the sixth embodiment of the present invention further includes at least two supports 110, which are integrally formed with the front end of the press-fit hole 402 in the frame 400 of the vehicle body so as to be in close contact with the front surface of the rubber part 200 and are integrally formed with the rear end of the outer pipe 100 so as to be in close contact with the rear surface of the rubber part 200, and a bulge part 310, which is integrally formed with the outer circumferential portion of the inner pipe 300 so as to compress or expand the rubber part 200 in the same direction as the direction of movement of the inner pipe 300, which moves in the longitudinal direction of the vehicle.

The supports 110 formed at the front end of the press-fit hole 402 in the frame 400 of the vehicle body may be attached thereto through welding or the like. The supports 110 formed at the rear end of the outer pipe 100 may be attached thereto through welding or the like, or may be bent and extend therefrom so as to be in close contact with the rear surface of the rubber part 200.

According to the sixth embodiment of the present invention, as shown in FIGS. 11A to 11C, the supports 110 may include a front-left support 111 and a front-right support 112, which are attached to the front end of the press-fit hole 402 in the frame 400 of the vehicle body at left and right positions so as to be in close contact with the front surface of the rubber part 200 and support the rubber part 200 together with the bulge part 310 so as to compress and expand the rubber part 200, and may further include a rear-upper support 116 and a rear-lower support 117, which are integrally formed with the rear end of the outer pipe 100 at upper and lower positions so as to be in close contact with the rear surface of the rubber part 200 and support the rubber part 200 together with the bulge part 310 so as to compress and expand the rubber part 200.

In this case, each of the front-left support 111 and the front-right support 112 may be formed in the shape of a plate, and may be made of the same metal material as that of the frame 400 of the vehicle body. The front-left support 111 and the front-right support 112 may be disposed in a direction perpendicular to the longitudinal direction of the outer pipe 100 so as to be in close contact with the front surface of the rubber part 200. Each of the rear-upper support 116 and the rear-lower support 117 may be formed in the shape of a plate, and may be made of the same metal material as that of the outer pipe 100. The rear-upper support 116 and the rear-lower support 117 may be bent and extend from the outer pipe 100 toward the rear surface of the rubber part 200 in a direction perpendicular to the longitudinal direction of the outer pipe 100.

According to the sixth embodiment of the present invention, as shown in FIG. 11D, the bulge part 310 may include a left bulge plate 311 and a right bulge plate 312, which protrude leftwards and rightwards from the middle portion in the longitudinal direction of the outer circumferential portion of the inner pipe 300 so as to be embedded into the rubber part 200 and are disposed so as to be aligned with the front-left support 111 and the front-right support 112 in the longitudinal direction, and may further include an upper bulge plate 316 and a lower bulge plate 317, which protrude upwards and downwards from the middle portion in the longitudinal direction of the outer circumferential portion of the inner pipe 300 so as to be embedded into the rubber part 200 and are disposed so as to be aligned with the rear-upper support 116 and the rear-lower support 117 in the longitudinal direction.

According to the sixth embodiment of the present invention, front stoppers 201 protrude from the front surface of the rubber part 200 at left and right positions so as to be in close contact with the front-left support 111 and the front-right support 112, and rear stoppers 202 protrude from the rear surface of the rubber part 200 at upper and lower positions so as to be in close contact with the rear-upper support 116 and the rear-lower support 117.

The outer pipe 100 is press-fitted into the press-fit hole formed in the frame of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the sixth embodiment of the present invention is disposed in the longitudinal direction of the vehicle.

As described above, according to the sixth embodiment of the present invention, some of the supports 110, i.e. the front-left support 111 and the front-right support 112, are formed at the front end of the press-fit hole 402 in the frame 400 of the vehicle body, rather than being formed at the front end of the outer pipe 100, thereby facilitating manufacture and assembly of the outer pipe.

In addition, according to the sixth embodiment of the present invention, as shown in FIG. 11G, the length that the front stoppers 201 of the rubber part 200, which are in close contact with the front-left support 111 and the front-right support 112, protrude may be longer than the length that the rear stoppers 202 protrude in order to maintain a state in which the rubber part 200 is compressed to a predetermined extent in the axial direction by a preload.

The outer pipe 100 is press-fitted into the press-fit hole 402 formed in the frame 400 of the vehicle body in the longitudinal direction of the vehicle, and the inner pipe 300 is connected to the PE part (e.g. the motor or the speed reducer) by means of a bolt fastened into the bolt hole 302. In this way, the bush-type mount according to the sixth embodiment of the present invention is disposed in the longitudinal direction of the vehicle.

Hereinafter, the operation of the bush-type mount according to the sixth embodiment of the present invention will be described.

As shown in FIG. 11E, when the inner pipe 300 moves toward the front side of the vehicle due to acceleration/deceleration shock of the vehicle or external impacts such as vibrations transferred from the road, the portion of the rubber part 200 that is located between the front-left and front-right supports 111 and 112 of the supports 110 and the left and right bulge plates 311 and 312 of the bulge part 310 is compressed in the axial direction (the longitudinal direction), whereby the axial property (stiffness) of the rubber part 200 may increase.

Also, as shown in FIG. 11F, when the inner pipe 300 moves toward the rear side of the vehicle due to acceleration/deceleration shock of the vehicle or external impacts such as vibrations transferred from the road, the portion of the rubber part 200 that is located between the rear-upper and rear-lower supports 116 and 117 of the supports 110 and the upper and lower bulge plates 316 and 317 of the bulge part 310 is compressed in the axial direction, whereby the axial property of the rubber part 200 may increase.

As described above with reference to FIG. 4, in the case in which one bush-type mount is mounted at a relatively forward position such that the axial direction thereof is parallel to the longitudinal direction of the vehicle and two bush-type mounts are mounted at two relatively rearward positions such that the axial directions thereof are parallel to the lateral direction of the vehicle, the property of the entire mount system in the axial direction (the property in the longitudinal direction of the vehicle) is lowered because each of the bush-type mounts is formed such that the axial property thereof is set to be lower than the radial property thereof, thus failing to appropriately respond to impacts and aftershock and accordingly deteriorating driving performance. However, since the bush-type mount according to the sixth embodiment of the present invention exhibits a high axial property, it is possible to solve the problem of deterioration in driving performance due to external impacts and aftershock.

Further, according to the sixth embodiment of the present invention, some of the supports 110, i.e. the front-left support 111 and the front-right support 112, are formed at the front end of the press-fit hole 402 in the frame 400 of the vehicle body, rather than being formed at the front end of the outer pipe 100, thereby facilitating manufacture and assembly of the outer pipe.

Furthermore, when the outer pipe 100 of the bush-type mount according to the sixth embodiment of the present invention is press-fitted into the press-fit hole 402 in the frame 400 of the vehicle body, the rubber part 200 may be maintained in the state of being compressed to a predetermined extent in the axial direction by a preload.

To this end, as described above, the length that the front stoppers 201 of the rubber part 200, which are in close contact with the front-left support 111 and the front-right support 112, protrude is set to be longer than the length that the rear stoppers 202 protrude.

Accordingly, when the outer pipe 100 is press-fitted into the press-fit hole 402 in the frame 400 of the vehicle body, as shown in FIG. 11G, the rubber part 200 is compressed by a preload while the front stoppers 201 of the rubber part 200 come into close contact with the front-left support 111 and the front-right support 112 formed at the frame 400 of the vehicle body. As a result, the axial property of the rubber part 200 increases after assembly of the bush-type mount according to the sixth embodiment of the present invention.

On the other hand, as a modification of the bush-type mount according to the sixth embodiment of the present invention, the supports 110 and the bulge part 310 may be formed to be tilted at a predetermined angle in order to adjust the extent of com pression and the property of the rubber part 200.

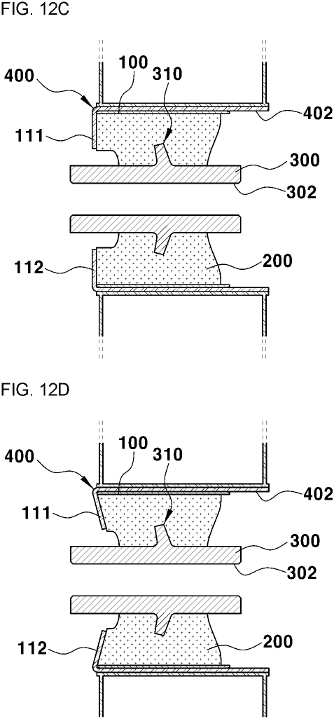

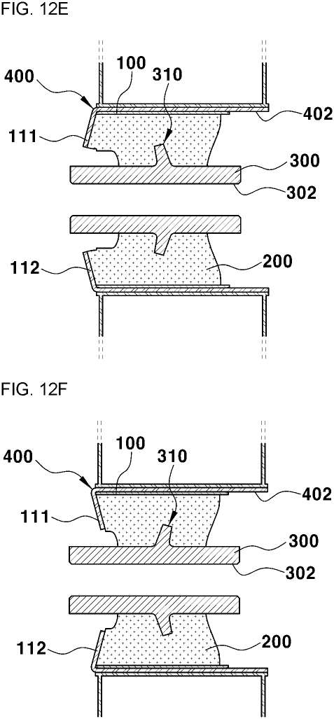

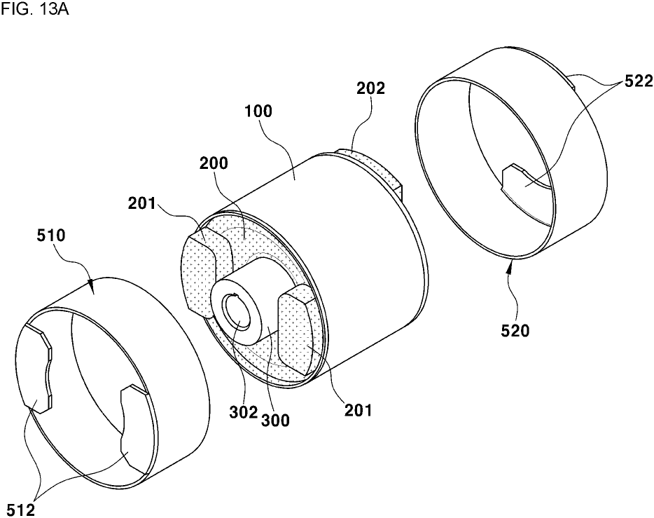

FIGS. 12A to 12F are cross-sectional views showing modifications of the bush-type mount according to the sixth embodiment of the present invention.

As a modification of the bush-type mount according to the sixth embodiment of the present invention, as shown in FIG. 12A, the bulge part 310 formed at the inner pipe 300 may be formed to be tilted backwards at a predetermined angle, and thus the volume of the portion of the rubber part 200 that can be compressed between the bulge part 310 and the front-left and front-right supports 111 and 112 formed at the frame 400 of the vehicle body may increase. Accordingly, when the inner pipe 300 moves forwards, the portion of the rubber part 200 that is located between the bulge part 310 and the front-left and front-right supports 111 and 112 formed at the frame 400 of the vehicle body may be compressed to a greater extent, whereby the axial property of the rubber part 200 may increase.

As a modification of the bush-type mount according to the sixth embodiment of the present invention, as shown in FIG. 12B, the bulge part 310 formed at the inner pipe 300 may be formed to be tilted backwards at a predetermined angle, the front-left support 111 and the front-right support 112 formed at the frame 400 of the vehicle body may be formed to be tilted forwards at substantially the same angle as that of the bulge part 310, and thus the volume of the portion of the rubber part 200 that can be compressed between the bulge part 310 and the front-left and front-right supports 111 and 112 formed at the frame 400 of the vehicle body may further increase. Accordingly, when the inner pipe 300 moves forwards, the portion of the rubber part 200 that is located between the bulge part 310 and the front-left and front-right supports 111 and 112 formed at the frame 400 of the vehicle body may be compressed to a much greater extent, whereby the axial property of the rubber part 200 may further increase.

As a modification of the bush-type mount according to the sixth embodiment of the present invention, as shown in FIG. 12C, the bulge part 310 formed at the inner pipe 300 may be formed to be tilted forwards at a predetermined angle, and thus the volume of the portion of the rubber part 200 that can be compressed between the bulge part 310 and the front-left and front-right supports 111 and 112 formed at the frame 400 of the vehicle body may decrease. Accordingly, when the inner pipe 300 moves forwards, the portion of the rubber part 200 that is located between the bulge part 310 and the front-left and front-right supports 111 and 112 formed at the frame 400 of the vehicle body may be compressed to a lower extent, whereby the axial property of the rubber part 200 may decrease.

As a modification of the bush-type mount according to the sixth embodiment of the present invention, as shown in FIG. 12D, the bulge part 310 formed at the inner pipe 300 may be formed to be tilted forwards at a predetermined angle, the front-left support 111 and the front-right support 112 formed at the frame 400 of the vehicle body may be formed to be tilted backwards at substantially the same angle as that of the bulge part 310, and thus the volume of the portion of the rubber part 200 that can be compressed between the bulge part 310 and the front-left and front-right supports 111 and 112 formed at the frame 400 of the vehicle body may further decrease. Accordingly, when the inner pipe 300 moves forwards, the portion of the rubber part 200 that is located between the bulge part 310 and the front-left and front-right supports 111 and 112 formed at the frame 400 of the vehicle body may be compressed to a much lower extent, whereby the axial property of the rubber part 200 may further decrease.

As a modification of the bush-type mount according to the sixth embodiment of the present invention, as shown in FIG. 12E, in order to adjust the extent of compression, the axial property, and the radial property of the rubber part of the bush-type mount, the bulge part 310 formed at the inner pipe 300 may be formed to be tilted forwards at a predetermined angle, and the front-left support 111 and the front-right support 112 may be formed to be tilted forwards at substantially the same angle as that of the bulge part 310.

As a modification of the bush-type mount according to the sixth embodiment of the present invention, as shown in FIG. 12F, in order to adjust the extent of compression, the axial property, and the radial property of the rubber part of the bush-type mount, the bulge part 310 formed at the inner pipe 300 may be formed to be tilted backwards at a predetermined angle, and the front-left support 111 and the front-right support 112 may be formed to be tilted backwards at substantially the same angle as that of the bulge part 310.

### Seventh Embodiment

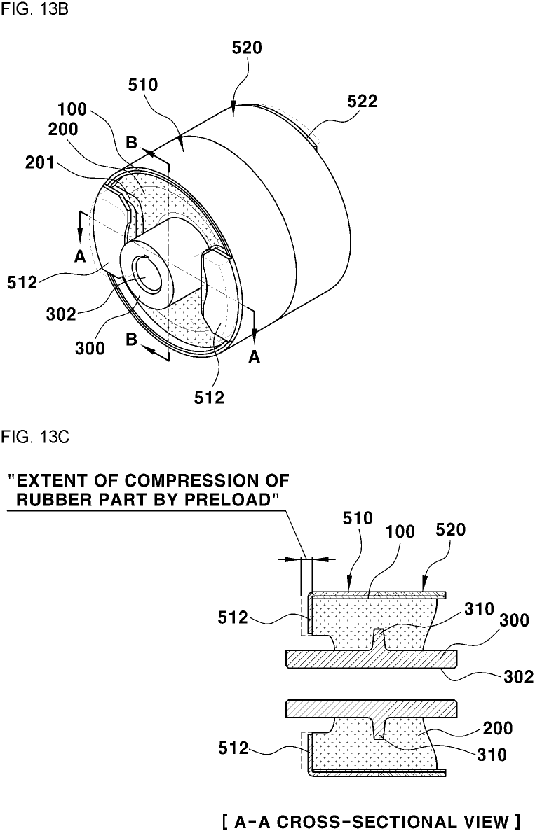

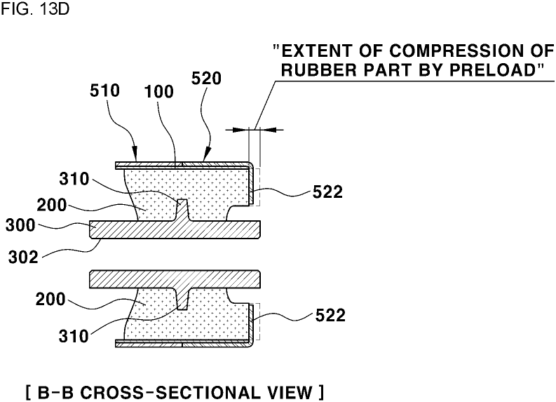

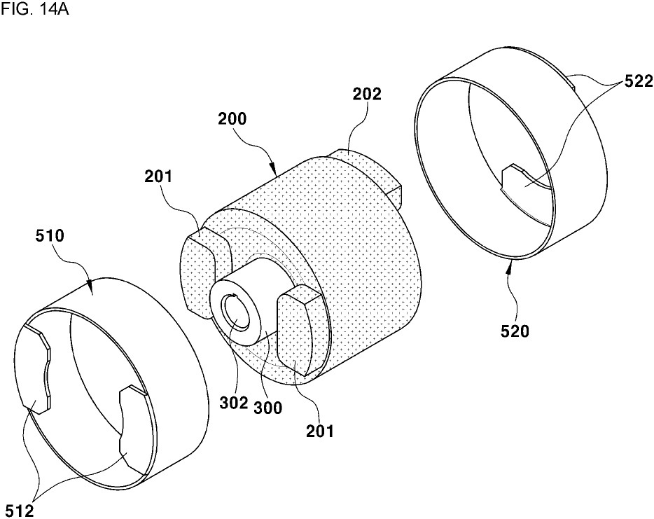

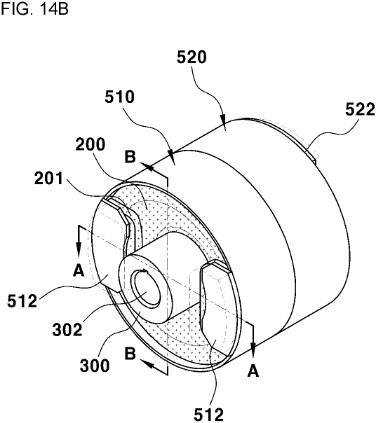

FIG. 13A is an exploded perspective view showing a bush-type mount according to a seventh embodiment of the present invention, FIG. 13B is a perspective view showing the assembled state of the bush-type mount according to the seventh embodiment of the present invention, and FIGS. 13C and 13D are cross-sectional views showing the bush-type mount according to the seventh embodiment of the present invention.

The bush-type mount according to the seventh embodiment of the present invention is characterized in that first and second separate outer pipes 510 and 520, at which supports 110 are formed, are fitted onto an outer pipe 100.

As shown in FIG. 13A, the bush-type mount according to the seventh embodiment of the present invention basically includes an outer pipe 100, an inner pipe 300, which has a bolt hole 302 formed therein so as to be mounted to a PE part and is disposed inside the outer pipe 100 so as to be oriented in the longitudinal direction, and a rubber part 200, which is formed in a vulcanization-molding process so as to fill the space between the outer pipe 100 and the inner pipe 300.

As shown in FIGS. 13A and 13B, the bush-type mount according to the seventh embodiment of the present invention is characterized by further including a first separate outer pipe 510, which has at least two front supports 512 formed so as to be in close contact with the front surface of the rubber part 200 and is press-fitted onto the front portion of the outer circumferential portion of the outer pipe 100, and a second separate outer pipe 520, which has at least two rear supports 522 formed so as to be in close contact with the rear surface of the rubber part 200 and is press-fitted onto the rear portion of the outer circumferential portion of the outer pipe 100.

In addition, as shown in FIGS. 13C and 13D, a bulge part 310 protrudes from the outer circumferential portion of the inner pipe 300 in order to compress or expand the rubber part 200 in the same direction as the direction of movement of the inner pipe 300, which moves in the longitudinal direction of the vehicle.

In addition, front stoppers 201 protrude from the front surface of the rubber part 200 so as to be in close contact with the front supports 512, and rear stoppers 202 protrude from the rear surface of the rubber part 200 so as to be in close contact with the rear supports 522.

Preferably, the lengths that the front stoppers 201 and the rear stoppers 202 protrude are set to lengths by which the rubber part 200 can be compressed by the front supports 512 and the rear supports 522 when the first separate outer pipe 510 and the second separate outer pipe 520 are fitted onto the outer circumferential portion of the outer pipe 100 and come into contact with each other.

Accordingly, as shown in FIGS. 13C and 13D, after the bush-type mount according to the seventh embodiment of the present invention is assembled, the rubber part 200 may be maintained in the state of being compressed to a predetermined extent in the axial direction by a preload generated by the front supports 512 of the first separate outer pipe 510 pressing the front stoppers 201 and the rear supports 522 of the second separate outer pipe 520 pressing the rear stoppers 202, whereby the axial property of the bush-type mount according to the seventh embodiment may increase.

As described above, according to the seventh embodiment of the present invention, due to the first and second separate outer pipes 510 and 520 having the supports, swaging may be easily performed on the outer pipe 100 of the bush-type mount, the durability of the bush-type mount may be improved, and the axial property of the bush-type mount may be increased by a preload.

### Eighth Embodiment

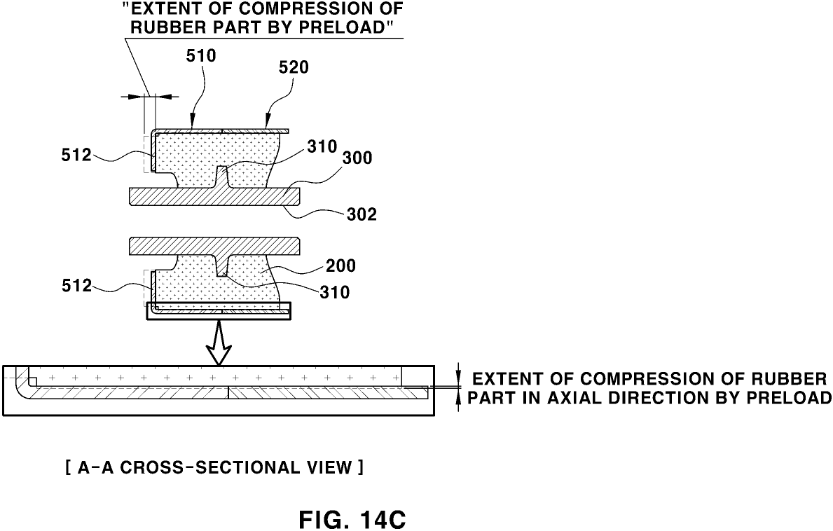

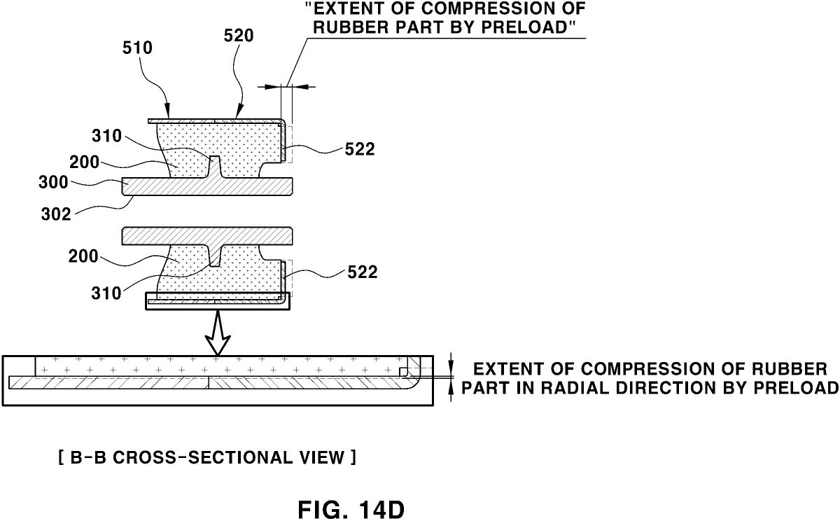

FIG. 14A is an exploded perspective view showing a bush-type mount according to an eighth embodiment of the present invention, FIG. 14B is a perspective view showing the assembled state of the bush-type mount according to the eighth embodiment of the present invention, and FIGS. 14C and 14D are cross-sectional views showing the bush-type mount according to the eighth embodiment of the present invention.

The bush-type mount according to the eighth embodiment of the present invention is characterized in that a first separate outer pipe 510 and a second separate outer pipe 520 are directly fitted onto the outer circumferential portion of a rubber part 200.

That is, the bush-type mount according to the eighth embodiment of the present invention is characterized in that an outer pipe is eliminated and a first separate outer pipe 510 and a second separate outer pipe 520 are directly fitted onto the outer circumferential portion of a rubber part 200.

To this end, as shown in FIGS. 14A and 14B, the bush-type mount according to the eighth embodiment of the present invention may include an inner pipe 300, which has a bolt hole 302 formed therein so as to be mounted to a PE part, a rubber part 200, which is formed on the outer circumferential portion of the inner pipe 300 in a vulcanization-molding process, a first separate outer pipe 510, which has at least two front supports 512 formed so as to be in close contact with the front surface of the rubber part 200 and is press-fitted onto the front portion of the outer circumferential portion of the rubber part 200, and a second separate outer pipe 520, which has at least two rear supports 522 formed so as to be in close contact with the rear surface of the rubber part 200 and is press-fitted onto the rear portion of the outer circumferential portion of the rubber part 200.

In addition, as shown in FIGS. 14C and 14D, a bulge part 310 protrudes from the outer circumferential portion of the inner pipe 300 in order to compress or expand the rubber part 200 in the same direction as the direction of movement of the inner pipe 300, which moves in the longitudinal direction of the vehicle.

In addition, front stoppers 201 protrude from the front surface of the rubber part 200 so as to be in close contact with the front supports 512, and rear stoppers 202 protrude from the rear surface of the rubber part 200 so as to be in close contact with the rear supports 522.

Preferably, the lengths that the front stoppers 201 and the rear stoppers 202 protrude are set to lengths by which the rubber part 200 can be compressed by the front supports 512 and the rear supports 522 when the first separate outer pipe 510 and the second separate outer pipe 520 are fitted onto the outer circumferential portion of the rubber part 200 and come into contact with each other.

Further, according to the eighth embodiment of the present invention, in order to maintain the state in which the rubber part 200 is compressed to a predetermined extent in the radial direction, the outer diameter of the rubber part 200 may be greater than the inner diameters of the first separate outer pipe 510 and the second separate outer pipe 520.

Accordingly, as shown in FIGS. 14C and 14D, after the bush-type mount according to the eighth embodiment of the present invention is assembled, the rubber part 200 may be maintained in the state of being compressed to a predetermined extent in the axial direction by a preload generated by the front supports 512 of the first separate outer pipe 510 pressing the front stoppers 201 and the rear supports 522 of the second separate outer pipe 520 pressing the rear stoppers 202, whereby the axial property of the bush-type mount according to the eighth embodiment may increase.

Further, since the outer diameter of the rubber part 200 is greater than the inner diameters of the first separate outer pipe 510 and the second separate outer pipe 520, as can be seen from the enlarged views in FIGS. 14C and 14D, when the bush-type mount is assembled, the first separate outer pipe 510 and the second separate outer pipe 520 compress the rubber part 200 in the radial direction. Accordingly, the rubber part 200 may be maintained in the state of being compressed to a predetermined extent in the radial direction by a preload caused by the first separate outer pipe 510 and the second separate outer pipe 520, thereby increasing the radial property of the bush-type mount according to the eighth embodiment.

As described above, according to the eighth embodiment of the present invention, since the first and second separate outer pipes 510 and 520 having the supports are directly fitted onto the rubber part 200, it is possible to reduce the number of parts due to elimination of an outer pipe of the bush-type mount and to provide property adjustment freedom enabling an increase in the axial property and the radial property of the bush-type mount using a preload.

As is apparent from the above description, the present invention has the following effects.

First, it is possible to provide freedom of adjustment of the properties of the bush-type mount along three axes so as to increase the axial property of the bush-type mount to the level of the radial property thereof or to increase both the axial property and the radial property thereof after mounting of the bush-type mount, thereby appropriately adjusting the properties of an entire mount system in all directions irrespective of the direction in which the bush-type mount is disposed.

Second, since the bush-type mount according to the present invention exhibits a high axial property, it is possible to solve the problem associated with the conventional bush-type mount, which has a low axial property and thus fails to appropriately respond to impacts and aftershock and causes deterioration in driving performance.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A bush-type mount for a vehicle, comprising:
an outer pipe fitted into a press-fit hole formed in a frame of a vehicle body in a longitudinal direction of the vehicle;
an inner pipe having a bolt hole formed therein so as to be mounted to a PE part, the inner pipe being disposed inside the outer pipe so as to be oriented in the longitudinal direction;
a rubber part formed in a vulcanization-molding process so as to fill a space between the outer pipe and the inner pipe;
at least two supports integrally formed at a front end and a rear end of the outer pipe so as to be in close contact with a front surface and a rear surface of the rubber part; and
a bulge part integrally formed with an outer circumferential portion of the inner pipe to compress or expand the rubber part in a same direction as a direction of movement of the inner pipe, the inner pipe being mounted so as to move in the longitudinal direction.

2. The bush-type mount of claim 1, wherein the at least two supports comprise:
a front-left support and a front-right support integrally formed with the front end of the outer pipe at left and right positions so as to be in close contact with the front surface of the rubber part to support the rubber part together with the bulge part so as to compress and expand the rubber part; and
a rear-upper support and a rear-lower support integrally formed with the rear end of the outer pipe at upper and lower positions so as to be in close contact with the rear surface of the rubber part to support the rubber part together with the bulge part so as to compress and expand the rubber part.

3. The bush-type mount of claim 2, wherein the bulge part comprises:
a left bulge plate and a right bulge plate protruding leftwards and rightwards from the outer circumference of a lengthwise middle portion of the inner pipe so as to be embedded into the rubber part, the left bulge plate and the right bulge plate being disposed so as to be aligned with the front-left support and the front-right support in the longitudinal direction; and
an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the rear-upper support and the rear-lower support in the longitudinal direction.

4. The bush-type mount of claim 2, wherein the bulge part comprises:
an upper bulge plate and a lower bulge plate protruding upwards and downwards from a front portion of the outer circumferential portion of the inner pipe so as to be in close contact with the front surface of the rubber part, the upper bulge plate and the lower bulge plate being disposed so as to be aligned with the rear-upper support and the rear-lower support in the longitudinal direction; and
a left bulge plate and a right bulge plate protruding leftwards and rightwards from a rear portion of the outer circumferential portion of the inner pipe so as to be in close contact with the rear surface of the rubber part, the left bulge plate and the right bulge plate being disposed so as to be aligned with the front-left support and the front-right support in the longitudinal direction.

5. The bush-type mount of claim 2, wherein front stoppers protrude from the front surface of the rubber part at left and right positions so as to be in close contact with the front-left support and the front-right support, and rear stoppers protrude from the rear surface of the rubber part at upper and lower positions so as to be in close contact with the rear-upper support and the rear-lower support.

6. The bush-type mount of claim 1, wherein the at least two supports comprise:
a front-upper support and a front-lower support integrally formed with the front end of the outer pipe at upper and lower positions so as to be in close contact with the front surface of the rubber part to support the rubber part together with the bulge part so as to compress and expand the rubber part; and
a rear-upper support and a rear-lower support integrally formed with the rear end of the outer pipe at upper and lower positions so as to be in close contact with the rear surface of the rubber part to support the rubber part together with the bulge part so as to compress and expand the rubber part.

7. The bush-type mount of claim 6, wherein the bulge part comprises:
an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the front-upper support, the front-lower support, the rear-upper support, and the rear-lower support in the longitudinal direction.

8. The bush-type mount of claim 6, wherein front stoppers protrude from the front surface of the rubber part at upper and lower positions so as to be in close contact with the front-upper support and the front-lower support, and rear stoppers protrude from the rear surface of the rubber part at upper and lower positions so as to be in close contact with the rear-upper support and the rear-lower support.

9. The bush-type mount of claim 1, wherein the at least two supports comprise:
a front single support integrally formed with the front end of the outer pipe at a lower position so as to be in close contact with the front surface of the rubber part to support the rubber part together with the bulge part so as to compress and expand the rubber part; and
a rear single support integrally formed with the rear end of the outer pipe at an upper position so as to be in close contact with the rear surface of the rubber part to support the rubber part together with the bulge part so as to compress and expand the rubber part.

10. The bush-type mount of claim 9, wherein the bulge part comprises:
an upper bulge plate and a lower bulge plate protruding upwards and downwards from the outer circumference of a lengthwise middle portion of the inner pipe so as to be embedded into the rubber part, the lower bulge plate being disposed so as to be aligned with the front single support in the longitudinal direction, the upper bulge plate being disposed so as to be aligned with the rear single support in the longitudinal direction.

11. The bush-type mount of claim 9, wherein the bulge part comprises:
an upper bulge plate protruding upwards from the outer circumference of a front portion of the inner pipe so as to be in close contact with the front surface of the rubber part, the upper bulge plate being disposed so as to be aligned with the rear single support in the longitudinal direction; and
a lower bulge plate protruding downwards from the outer circumference of a rear portion of the inner pipe so as to be in close contact with the rear surface of the rubber part, the lower bulge plate being disposed so as to be aligned with the front single support in the longitudinal direction.

12. The bush-type mount of claim 9, wherein a front stopper protrudes from the front surface of the rubber part at a lower position so as to be in close contact with the front single support, and a rear stopper protrudes from the rear surface of the rubber part at an upper position so as to be in close contact with the rear single support.

13. The bush-type mount of claim 1, wherein a slit having a V-shaped cross section is formed in one side portion or in each of two opposite side portions of the outer pipe and the rubber part in a longitudinal direction thereof.

14. A bush-type mount for a vehicle, comprising:
an outer pipe fitted into a press-fit hole formed in a frame of a vehicle body in a longitudinal direction of the vehicle;
an inner pipe having a bolt hole formed therein so as to be mounted to a PE part, the inner pipe being disposed inside the outer pipe so as to be oriented in the longitudinal direction;
a rubber part formed in a vulcanization-molding process so as to fill a space between the outer pipe and the inner pipe;
at least two supports integrally formed at a front end of the press-fit hole so as to be in close contact with a front surface of the rubber part and integrally formed with a rear end of the outer pipe so as to be in close contact with a rear surface of the rubber part; and
a bulge part integrally formed with an outer circumferential portion of the inner pipe to compress or expand the rubber part in a same direction as a direction of movement of the inner pipe, the inner pipe being mounted so as to move in the longitudinal direction.

15. The bush-type mount of claim 14, wherein the at least two supports comprise:
a front-left support and a front-right support attached to the front end of the press-fit hole at left and right positions so as to be in close contact with the front surface of the rubber part to support the rubber part together with the bulge part so as to compress and expand the rubber part; and
a rear-upper support and a rear-lower support integrally formed with the rear end of the outer pipe at upper and lower positions so as to be in close contact with the rear surface of the rubber part to support the rubber part together with the bulge part so as to compress and expand the rubber part.

16. The bush-type mount of claim 15, wherein the bulge part comprises:
a left bulge plate and a right bulge plate protruding leftwards and rightwards from the outer circumference of a lengthwise middle portion of the inner pipe so as to be embedded into the rubber part, the left bulge plate and the right bulge plate being disposed so as to be aligned with the front-left support and the front-right support in the longitudinal direction; and
an upper bulge plate and a lower bulge plate protruding upwards and downwards from the outer circumference of a lengthwise middle portion of the inner pipe so as to be embedded into the rubber part, the upper bulge plate and the lower bulge plate being disposed so as to be aligned with the rear-upper support and the rear-lower support in the longitudinal direction.

17. The bush-type mount of claim 16, wherein, in order to increase an extent of compression of a portion of the rubber part that is located between the bulge part, the front-left support, and the front-right support when the inner pipe moves forwards, the bulge part is formed to be tilted backwards at a predetermined angle, and the front-left support and the front-right support are formed to be tilted forwards at substantially a same angle as the angle of the bulge part.

18. The bush-type mount of claim 16, wherein, in order to reduce an extent of com pression of a portion of the rubber part that is located between the bulge part, the front-left support, and the front-right support when the inner pipe moves forwards, the bulge part is formed to be tilted forwards at a predetermined angle, and the front-left support and the front-right support are formed to be tilted backwards at substantially a same angle as the angle of the bulge part.

19. The bush-type mount of claim 16, wherein, in order to adjust an extent of compression of a portion of the rubber part that is located between the bulge part, the front-left support, and the front-right support when the inner pipe moves forwards, the bulge part is formed to be tilted forwards at a predetermined angle, and the front-left support and the front-right support are formed to be tilted forwards at substantially a same angle as the angle of the bulge part.

20. The bush-type mount of claim 16, wherein, in order to adjust an extent of compression of a portion of the rubber part that is located between the bulge part, the front-left support, and the front-right support when the inner pipe moves forwards, the bulge part is formed to be tilted backwards at a predetermined angle, and the front-left support and the front-right support are formed to be tilted backwards at substantially a same angle as the angle of the bulge part.

21. The bush-type mount of claim 15, wherein front stoppers protrude from the front surface of the rubber part at left and right positions so as to be in close contact with the front-left support and the front-right support, rear stoppers protrude from the rear surface of the rubber part at upper and lower positions so as to be in close contact with the rear-upper support and the rear-lower support, and a length that the front stoppers, which are in close contact with the front-left support and the front-right support, protrude is set to be longer than a length that the rear stoppers protrude in order to maintain a state in which the rubber part is compressed to a predetermined extent in an axial direction by a preload.

22. A bush-type mount for a vehicle, comprising:
an outer pipe;
an inner pipe having a bolt hole formed therein so as to be mounted to a PE part, the inner pipe being disposed inside the outer pipe so as to be oriented in a longitudinal direction of the vehicle;
a rubber part formed in a vulcanization-molding process so as to fill a space between the outer pipe and the inner pipe;
a first separate outer pipe having at least two front supports formed so as to be in close contact with a front surface of the rubber part, the first separate outer pipe being press-fitted onto a front portion of an outer circumferential portion of the outer pipe;
a second separate outer pipe having at least two rear supports formed so as to be in close contact with a rear surface of the rubber part, the second separate outer pipe being press-fitted onto a rear portion of the outer circumferential portion of the outer pipe; and
a bulge part integrally formed with an outer circumferential portion of the inner pipe to compress or expand the rubber part in a same direction as a direction of movement of the inner pipe, the inner pipe being mounted so as to move in the longitudinal direction.

23. The bush-type mount of claim 22, wherein front stoppers protrude from the front surface of the rubber part so as to be in close contact with the at least two front supports, rear stoppers protrude from the rear surface of the rubber part so as to be in close contact with the at least two rear supports, and lengths that the front stoppers and the rear stoppers protrude are set to lengths by which the rubber part is capable of being compressed by the at least two front supports and the at least two rear supports when the first separate outer pipe and the second separate outer pipe are fitted onto the outer circumferential portion of the outer pipe and come into contact with each other in order to maintain a state in which the rubber part is compressed to a predetermined extent in an axial direction by a preload.

24. The bush-type mount of claim 23, wherein the first separate outer pipe and the second separate outer pipe are directly fitted onto an outer circumferential portion of the rubber part, and an outer diameter of the rubber part is greater than inner diameters of the first separate outer pipe and the second separate outer pipe in order to maintain a state in which the rubber part is compressed to a predetermined extent in a radial direction.
